(19) United States
(12) Patent Application Publication
(10) Pub. No.: US 2026/0252789 A1
(43) Pub. Date: Aug. 27, 2026

(54) SYSTEM

(71) Applicant: SoftBank Group Corp., Tokyo (JP)

(72) Inventor: Yoshihiro SUGIMOTO, Tokyo (JP)

(73) Assignee: SoftBank Group Corp., Tokyo (JP)

(21) Appl. No.: 19/534,807

(22) Filed: Feb. 10, 2026

(30) Foreign Application Priority Data
Feb. 21, 2025 (JP) 2025-026989

(51) Int. Cl. G06F 40/166; G06F 16/31; G06F 40/284; G06F 40/40

(52) U.S. Cl. CPC G06F 40/166; G06F 16/316; G06F 40/284; G06F 40/40

(57) ABSTRACT

The system according to the embodiment comprises a collection unit, an extraction unit, a summarization unit, and a provision unit. The collection unit collects read information. The extraction unit extracts unread topics based on the read information collected by the collection unit. The summarization unit summarizes the topics extracted by the extraction unit. The provision unit provides the information summarized by the summarization unit.

### CROSS-REFERENCE TO RELATED APPLICATION

The present application claims priority to and incorporates by reference the entire contents of Japanese Patent Application No. 2025-026989 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that it is difficult for a user to efficiently manage read information and unread information and to quickly catch up with unread topics.

### SUMMARY OF THE INVENTION

The system according to the embodiment comprises a collection unit, an extraction unit, a summarization unit, and a provision unit. The collection unit collects read information. The extraction unit extracts unread topics based on the read information collected by the collection unit. The summarization unit summarizes the topics extracted by the extraction unit. The provision unit provides the information summarized by the summarization unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5 th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

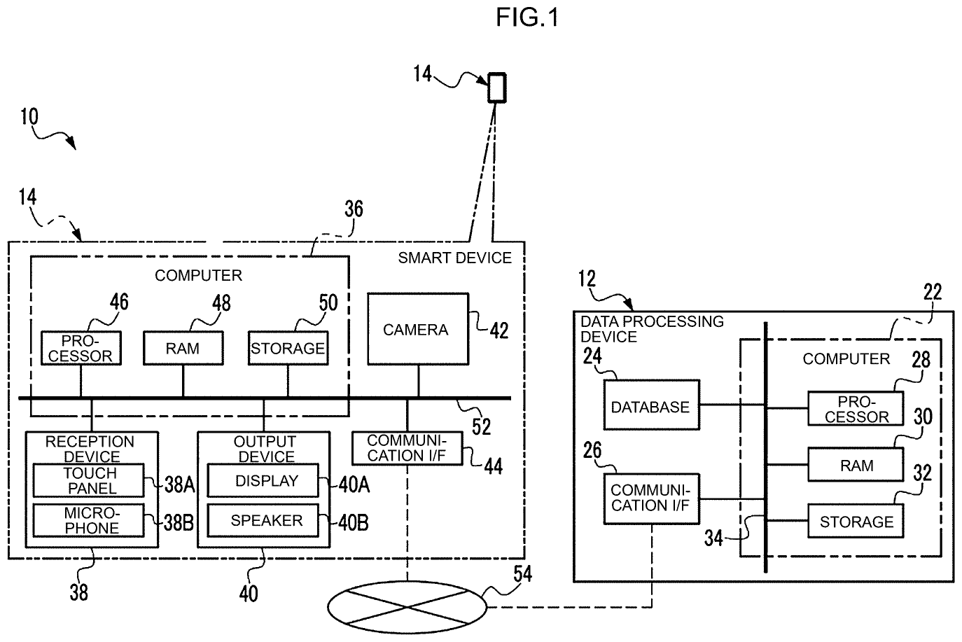

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

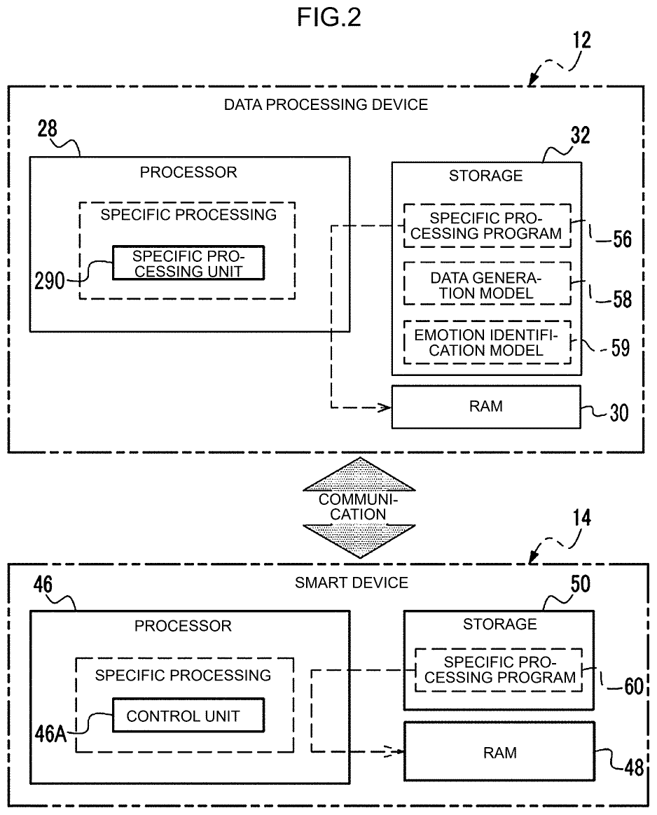

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The system according to the embodiment of the present invention utilizes the read processing of messenger applications and news applications, extracts only topics that the user has not caught up with, and summarizes them using AI, thereby enabling the user to catch up with current topics in the shortest time and without waste. This system collects read information from messenger applications and news applications to determine which news the user has already read. For example, it collects information on news links sent from friends via messenger applications and articles already viewed in news applications. Next, based on the collected read information, the system extracts topics that the user has not yet read. For example, it identifies unread news articles in news applications and unread news links in messenger applications. Furthermore, the extracted topics are summarized by AI. The AI analyzes the content of unread news articles or news links, extracts important points, and creates a summary. For example, by condensing long news articles into short summaries, the user can efficiently obtain information. Finally, the summarized topics are provided to the user. By checking the summarized information, the user can catch up with the latest topics in a short time. For example, the system provides summarized information to the user by utilizing the notification function of news applications or messenger applications. Through this mechanism, the user can efficiently catch up with the latest topics. For example, it is useful as a means for efficiently obtaining information for users with limited time, such as busy businesspersons or students. In addition, since the summary is performed by AI, the user can obtain accurate information without excess or deficiency. As a result, the system enables the user to efficiently catch up with the latest topics. Specifically, the system uses API integration or scraping technology to obtain structured data such as news article IDs or link URLs with unique identifiers for each user, read flags (e.g., boolean type), and read timestamps (e.g., ISO8601 format) from messenger applications and news applications. The system stores this data in a user-indexed database (e.g., NoSQL document store or RDBMS), performs deduplication and chronological management, and manages the user's read history quickly and accurately. In the extraction process, the system compares the collected read data with the complete list of news articles obtained from news applications and messenger applications (including article ID, title, category, publication date, body text, etc.) to identify unread articles. This identification process is implemented using high-speed search algorithms such as hash tables or bitmap indexes, enabling real-time extraction of unread articles even from tens of thousands of news data entries. Next, the system inputs the body text of unread articles (e.g., UTF-8 encoded natural language text, averaging 2,000 to 5,000 characters) or the content of linked web pages (text extracted after HTML parsing) into the AI summarization module. The AI summarization module uses, for example, a pre-trained large language model (e.g., encoder-decoder type Transformer architecture with billions to tens of billions of parameters), tokenizes the input text (e.g., subword segmentation, up to 4,096 tokens), and performs the summary generation task. Examples of AI input include “article body summarizing the key points of an international economic summit (3,000 characters)” or “full text of a news link including sports tournament results (2,500 characters).” The AI output is obtained as summary text (e.g., 200 to 400 characters of Japanese natural language, condensed into 3 to 5 important points), with output examples such as “An agreement was reached between Country A and Country B at the international economic summit, with the main topics being energy policy and trade agreements” or “In the sports tournament, Player X won, and the final match was closely contested.” The system performs post-processing on the AI output summary text, such as personalized filtering based on the user's field of interest and past browsing tendencies (e.g., category-based viewing frequency vectors, chronological access patterns), and quality evaluation of the summary (e.g., automatic evaluation using ROUGE or BLEU scores). Furthermore, when delivering the summary results to the user's device, the system can select multiple delivery methods, such as push notification APIs, in-app banner displays, or widget displays, and automatically select the optimal UI/UX according to the user's usage status and device type (smartphone, tablet, PC, etc.). As a technical effect, the system can process vast amounts of news data in real time and with high accuracy, unlike conventional manual read management or summarization work, thereby greatly reducing the burden of information overload for users and enabling them to catch up with necessary topics in the shortest possible time. In addition, AI-based summarization utilizes advanced natural language processing technologies such as contextual understanding, importance estimation, and automatic removal of redundant parts, rather than simple extraction or keyword extraction, greatly improving the comprehensiveness, accuracy, and conciseness of information. Application fields include support for catching up on current events for businesspersons, learning news summaries for students, specialized news digests for medical, legal, and financial fields, and emergency summary notifications during disasters, among other diverse use cases. Furthermore, the system is highly extensible, allowing for easy functional expansion through AI model version upgrades or combinations of multiple models (e.g., summarization model+emotion analysis model), and can flexibly respond to future technological advancements.

The information provision system according to the embodiment comprises a collection unit, an extraction unit, a summarization unit, and a provision unit. The collection unit collects news information that the user has already read. For example, the collection unit collects information on news links sent from friends via a messenger application and articles already viewed in a news application. The collection unit obtains read information on news links from the messenger application and information on read articles from the news application. The collection unit centrally manages this information to determine which news the user has already read. The extraction unit extracts topics that the user has not yet read based on the read information collected by the collection unit. For example, the extraction unit identifies unread news articles in a news application and unread news links in a messenger application. Through this, the extraction unit can determine topics that the user has not yet caught up with. The summarization unit summarizes the topics extracted by the extraction unit. For example, the summarization unit analyzes the content of unread news articles or news links, extracts important points, and creates a summary. The summarization unit uses generative AI to condense long news articles into short summaries. The generative AI, for example, uses a text generation AI (such as an LLM) to extract key points from news articles and generate summaries. The generative AI analyzes the content of news articles, extracts important information, and creates summaries. The provision unit provides the information summarized by the summarization unit to the user. For example, the provision unit provides summarized information to the user by utilizing the notification function of a news application or a messenger application. The provision unit quickly provides summarized information so that the user can efficiently obtain information. As a result, the information provision system according to the embodiment enables the user to efficiently catch up with the latest topics. Some or all of the above-described processing in the provision unit may be performed using AI or without using AI. For example, the provision unit may use an AI model for providing summarized information to the user. Specifically, the information provision system utilizes API integration or scraping technology in the collection unit to obtain structured data such as news article IDs, link URLs, read flags (boolean type), and read timestamps (ISO8601 format) with unique identifiers for each user. The system stores this data in a user-indexed database (such as a NoSQL document store or RDBMS), performs deduplication and chronological management, and manages the user's read history quickly and accurately. The extraction unit compares the read data obtained from the collection unit with the complete list of news articles obtained from news applications and messenger applications (article ID, title, category, publication date, body text, etc.), and uses high-speed search algorithms such as hash tables or bitmap indexes to identify unread articles. For example, real-time extraction of unread articles is possible even for more than 10,000 news data entries. The summarization unit inputs the body text of unread articles (UTF-8 encoded natural language text, averaging 2,000 to 5,000 characters) or the content of linked web pages (text extracted after HTML parsing) into the AI summarization module. The AI summarization module uses a pre-trained large language model (encoder-decoder type Transformer architecture with billions to tens of billions of parameters), tokenizes the input text by subword segmentation (up to 4,096 tokens), and performs the summary generation task. Examples of AI input include “article body summarizing the key points of an international economic summit (3,000 characters)” or “full text of a news link including sports tournament results (2,500 characters).” The AI output is obtained as summary text (200 to 400 characters of Japanese natural language, condensed into 3 to 5 important points), with output examples such as “An agreement was reached between Country A and Country B at the international economic summit, with the main topics being energy policy and trade agreements” or “In the sports tournament, Player X won, and the final match was closely contested.” The summarization unit performs post-processing on the AI output summary text, such as personalized filtering based on the user's field of interest and past browsing tendencies (category-based viewing frequency vectors, chronological access patterns), and quality evaluation of the summary (automatic evaluation using ROUGE or BLEU scores). The provision unit, when delivering the summary results to the user's device, can select multiple delivery methods, such as push notification APIs, in-app banner displays, or widget displays, and automatically select the optimal UI/UX according to the user's usage status and device type (smartphone, tablet, PC, etc.). As a technical effect, the information provision system can process vast amounts of news data in real time and with high accuracy, unlike conventional manual read management or summarization work, thereby greatly reducing the burden of information overload for users and enabling them to catch up with necessary topics in the shortest possible time. In addition, AI-based summarization utilizes advanced natural language processing technologies such as contextual understanding, importance estimation, and automatic removal of redundant parts, rather than simple extraction or keyword extraction, greatly improving the comprehensiveness, accuracy, and conciseness of information. Application fields include support for catching up on current events for businesspersons, learning news summaries for students, specialized news digests for medical, legal, and financial fields, and emergency summary notifications during disasters, among other diverse use cases. Furthermore, the information provision system is highly extensible, allowing for easy functional expansion through AI model version upgrades or combinations of multiple models (such as summarization model+emotion analysis model), and can flexibly respond to future technological advancements.

The summarization unit can analyze the content of unread news articles or news links, extract important points, and create a summary. For example, the summarization unit analyzes the content of unread news articles, extracts important points, and creates a summary. The summarization unit uses generative AI to extract key points from news articles and generate summaries. The generative AI, for example, uses a text generation AI (such as an LLM) to analyze the content of news articles, extract important information, and create summaries. The generative AI analyzes the content of news articles, extracts important information, and creates summaries. For example, the summarization unit analyzes the content of news links, extracts important points, and creates a summary. The summarization unit uses generative AI to extract key points from news links and generate summaries. The generative AI, for example, uses a text generation AI (such as an LLM) to analyze the content of news links, extract important information, and create summaries. The generative AI analyzes the content of news links, extracts important information, and creates summaries. Thus, the summarization unit can efficiently summarize the content of unread news articles or news links. Specifically, the summarization unit receives the body text of unread news articles or the full text of news links (UTF-8 encoded natural language text, averaging 2,000 to 5,000 characters) as input data. The summarization unit converts the input text into up to 4,096 tokens using tokenizers such as subword segmentation or byte pair encoding, and inputs it into a large language model with an encoder-decoder type Transformer architecture (with billions to tens of billions of parameters). Examples of input include “article body summarizing the key points of an international economic summit (3,000 characters)” or “full text of a news link including sports tournament results (2,500 characters).” Within the AI model, the summarization unit uses multi-layer self-attention mechanisms to extract contextual information in high-dimensional space, and optimizes weights to minimize the loss function for summary generation tasks (e.g., cross-entropy loss) through importance estimation heads and redundancy removal modules. The summarization unit generates output as Japanese natural language text of about 200 to 400 characters (condensed into 3 to 5 important points), with examples such as “An agreement was reached between Country A and Country B at the international economic summit, with the main topics being energy policy and trade agreements” or “In the sports tournament, Player X won, and the final match was closely contested.” The summarization unit performs post-processing on the AI output summary text, such as personalized filtering based on the user's field of interest and past browsing tendencies (category-based viewing frequency vectors, chronological access patterns), and quality evaluation of the summary (automatic evaluation using ROUGE or BLEU scores). Unlike conventional manual summarization or simple keyword extraction, the summarization unit utilizes advanced natural language processing technologies such as contextual understanding, importance estimation, and automatic removal of redundant parts, thereby greatly improving the comprehensiveness, accuracy, and conciseness of information. As a technical effect, the summarization unit can summarize vast amounts of news data in real time and with high accuracy, greatly reducing the burden of information overload for users and enabling them to catch up with necessary topics in the shortest possible time. Application fields include support for catching up on current events for businesspersons, learning news summaries for students, specialized news digests for medical, legal, and financial fields, and emergency summary notifications during disasters, among other diverse use cases. Furthermore, the summarization unit is highly extensible, allowing for easy functional expansion through AI model version upgrades or combinations of multiple models (such as summarization model+emotion analysis model), and can flexibly respond to future technological advancements.

The provision unit can provide summarized information to the user by utilizing the notification function of a news application or a messenger application. For example, the provision unit provides summarized information to the user by utilizing the notification function of a news application. The provision unit uses the notification function of a news application to quickly provide summarized information to the user. For example, the provision unit provides summarized information to the user by utilizing the notification function of a messenger application. The provision unit uses the notification function of a messenger application to quickly provide summarized information to the user. Thus, the provision unit can quickly provide summarized information to the user. Specifically, the provision unit delivers the summary text received from the summarization unit (e.g., 200 to 400 characters of Japanese natural language, condensed into 3 to 5 important points) via a notification API optimized for the user's device type (smartphone, tablet, PC, etc.) and OS (iOS, Android, Windows, etc.), such as Firebase Cloud Messaging or Apple Push Notification Service. The provision unit packages the summary text together with metadata such as article title, category, summary generation date and time, and related image URLs in JSON format, and adapts it to display templates on the device side (banner, popup, widget, etc.). Furthermore, the provision unit can implement algorithms to personalize notification timing and display format based on the user's notification reception history and reactions (e.g., notification open rate, immediate read rate, notification snooze count) recorded chronologically, such as reinforcement learning-based optimization or user state estimation models. Examples of AI-generated summary output include “An agreement was reached between Country A and Country B at the international economic summit, with the main topics being energy policy and trade agreements” or “In the sports tournament, Player X won, and the final match was closely contested,” which are delivered as notification content. After notification delivery, the provision unit collects feedback from the user's device (e.g., notification click, notification ignored, notification deleted) in real time and returns feedback data to the summarization unit or extraction unit to continuously improve the personalization accuracy of summary generation and topic extraction. As a technical effect, the provision unit, unlike conventional uniform notifications or manual delivery, combines AI summarization and user behavior analysis to realize real-time, high-precision information delivery optimized for each user, greatly improving immediacy, efficiency, and user satisfaction in information transmission. Application fields include breaking news notifications for businesspersons, learning news delivery for students, specialized information alerts for medical, legal, and financial fields, and emergency notifications during disasters, among other diverse use cases according to user attributes and usage scenarios. In addition, the provision unit functions as a highly extensible and reliable information delivery platform, supporting multiple notification channels (email, SMS, in-app notifications, etc.), multilingual support, and retry delivery functions in case of failures.

The collection unit can collect information on news links sent from friends via a messenger application or articles already viewed in a news application. For example, the collection unit collects information on news links sent from friends via a messenger application. The collection unit obtains read information on news links from the messenger application to determine which news links the user has already read. For example, the collection unit collects information on articles already viewed in a news application. The collection unit obtains information on read articles from the news application to determine which news articles the user has already read. Thus, the collection unit can efficiently collect news information that the user has already viewed. Specifically, the collection unit automatically obtains structured data such as news article IDs, link URLs, read flags (boolean type), read timestamps (ISO8601 format), and sender IDs (friend IDs) with unique identifiers (e.g., user ID, device ID) for each user using API integration or scraping technology from messenger applications and news applications. The collection unit stores the obtained data in databases such as NoSQL document stores or RDBMS, and performs indexing, deduplication, and chronological management on a per-user basis to achieve fast search and accurate management of read history. Furthermore, as preprocessing of the obtained data, the collection unit performs URL normalization, article title extraction, category assignment, and summary generation of body text to improve processing efficiency in subsequent extraction and summarization units. Examples of AI model input include “economic news link sent by Friend A (URL, send time, read flag true)” or “sports article already viewed in news application (article ID, category, read time).” The collection unit updates this data periodically by batch or stream processing to reflect the user's latest read status in real time. As a technical effect, the collection unit, unlike conventional manual recording or simple browsing history management, integrates and automates read information across multiple applications, enabling accurate and fast understanding of the user's information acquisition status, thereby greatly improving the accuracy and efficiency of unread topic extraction and summary generation. Application fields include personal news aggregation, corporate information sharing, learning history management in education, and specialized information tracking in medical and legal fields, among other diverse use cases. In addition, the collection unit is highly extensible, capable of flexibly responding to API specification changes and addition of new applications, and can adapt to future technological advancements.

The extraction unit can identify unread news articles in a news application or unread news links in a messenger application. For example, the extraction unit identifies unread news articles in a news application. The extraction unit obtains information on unread news articles from the news application to identify news articles that the user has not yet read. For example, the extraction unit identifies unread news links in a messenger application. The extraction unit obtains information on unread news links from the messenger application to identify news links that the user has not yet read. Thus, the extraction unit can efficiently identify news information that the user has not yet read. Specifically, the extraction unit compares the read data obtained from the collection unit (e.g., article ID, read flag, read time) with the complete list of news articles obtained from news applications and messenger applications (article ID, title, category, publication date, body text, etc.) using high-speed search algorithms such as hash tables or bitmap indexes, and identifies unread articles or unread links in real time. The extraction unit achieves unread extraction for tens of thousands of news data entries with computational complexity of O(1) or O(logN), and generates unread lists for each user. After identifying unread articles, the extraction unit assigns metadata such as article category, publication date, sender attributes (friend ID, etc.), and related keywords, and utilizes them in subsequent summarization and personalization processing. Examples of AI model input include “unread economic news article (article ID, title, category, publication date, body)” or “unread sports news link (URL, sender ID, send time).” The extraction unit manages identified unread information chronologically and can also prioritize according to the user's browsing tendencies and field of interest (e.g., category weighting, prioritizing latest articles, etc.). As a technical effect, the extraction unit, unlike conventional manual search or simple list comparison, uses high-speed index structures and automated algorithms to extract optimal unread topics for each user in real time from vast news data, greatly improving the efficiency and accuracy of information acquisition. Application fields include personal news readers, corporate information sharing, learning progress management in education, and specialized information extraction in medical and legal fields, among other diverse use cases. In addition, the extraction unit allows easy customization of extraction conditions and prioritization logic, enabling flexible operation according to user attributes and usage scenarios.

The collection unit can estimate the user's emotion and adjust the timing of collecting read information based on the estimated emotion of the user. For example, if the user is feeling stressed, the collection unit delays the collection timing and collects information when the user is relaxed. By estimating the user's emotion and collecting information when the user is relaxed, the collection unit reduces the user's burden. For example, if the user is relaxed, the collection unit immediately collects read information and provides the latest information. By estimating the user's emotion and collecting information when the user is relaxed, the collection unit enables the user to efficiently obtain information. For example, if the user is busy, the collection unit adjusts the collection timing and collects information when the user is calm. By estimating the user's emotion and collecting information when the user is calm, the collection unit enables the user to efficiently obtain information. Thus, the collection unit can collect read information at the optimal timing according to the user's emotion. Emotion estimation is realized using, for example, an emotion engine or generative AI with emotion estimation functions. Generative AI may be a text generation AI (such as an LLM) or a multimodal generative AI, but is not limited to these examples. Specifically, the collection unit collects multidimensional feature vectors (e.g., float arrays, 20 to 100 dimensions) from biometric sensor data obtainable from the user's device (e.g., heart rate, skin conductance, facial images, voice tone), in-app behavior logs (e.g., tap frequency, screen transition speed, input text content), and external environmental information (e.g., calendar events, time, location). The collection unit inputs these feature vectors into an emotion estimation AI module. The emotion estimation AI module uses, for example, a multimodal Transformer architecture (integrating text, images, and voice, with hundreds of millions to billions of parameters), normalizes and embeds the input vectors, and performs emotion classification tasks (e.g., stress, relaxation, excitement, fatigue, calmness). Examples of AI input include “user's voice tone (high-pitched, fast), heart rate 95 bpm, recent input text ‘in a hurry’” or “smile detected from facial image, free time in calendar, decreased tap frequency.” AI output is obtained as emotion labels (e.g., ‘relaxation’, ‘stress’, ‘busy’, etc.) and confidence scores (e.g., 0.92, 0.85 as float values). Output examples include “emotion label: relaxation, confidence 0.88” or “emotion label: stress, confidence 0.93.” Based on the AI output emotion label and confidence, the collection unit's timing control module automatically determines the read information collection scheduler (e.g., immediate collection, 10-minute delay, retry after 1 hour). As post-processing, the collection timing history is recorded in a time-series database, and user-specific optimization parameters (e.g., 30-minute delay during stress, immediate collection during relaxation) can be sequentially updated using reinforcement learning algorithms. As a technical effect, the collection unit, unlike conventional uniform timing information collection, dynamically optimizes collection timing according to the user's real-time emotional state, greatly improving user experience quality and reducing psychological burden and stress from information acquisition. Furthermore, AI-based emotion estimation enables complex state estimation that is difficult to achieve with human subjective judgment or simple time-of-day rules, realizing an information collection flow optimized for each user. Application fields include business information notifications for businesspersons, learning progress management for students, patient state monitoring in medical and welfare fields, and mental health care support, among other diverse use cases. In addition, the collection unit is highly extensible, allowing for easy functional expansion through emotion estimation AI version upgrades, addition of new sensor data, and integration of multiple AI models (e.g., emotion estimation+behavior prediction model), and can flexibly respond to future technological advancements.

The collection unit can analyze the user's past browsing history and select a collection method. For example, the collection unit prioritizes the collection of news categories that the user frequently browses. By analyzing the user's past browsing history and prioritizing the collection of news categories that the user frequently browses, the collection unit efficiently collects information of interest to the user. For example, the collection unit analyzes the tendency of articles that the user has spent a long time viewing in the past and prioritizes the collection of similar content. By analyzing the user's past browsing history and the tendency of articles that the user has spent a long time viewing, the collection unit efficiently collects information of interest to the user. For example, if the user tends to browse at specific times of day, the collection unit collects information according to those times. By analyzing the user's past browsing history and collecting information according to the times when the user tends to browse, the collection unit enables the user to efficiently obtain information. Thus, the collection unit can collect read information in the optimal way based on the user's past browsing history. Specifically, the collection unit periodically obtains structured data such as article ID, category, browsing start and end time, browsing duration (in seconds), article title, body length, device type, and source application from a user-indexed browsing history database (e.g., NoSQL document store, RDBMS) for each user. The collection unit aggregates these history data as feature vectors (e.g., category-based browsing frequency vectors, time-of-day access histograms, article length distributions) and inputs them into a user profile generation AI module. The AI module uses, for example, a temporal convolutional neural network (TCN) or LSTM-type recurrent neural network to analyze browsing patterns over the past 30 days (e.g., 24 hours per day×30 days=720-dimensional time-series vector). Examples of AI input include “number of views per category over the past 30 days (e.g., economics 50 times, sports 30 times, entertainment 20 times),” “access concentrated on weekdays from 19:00 to 22:00,” or “long articles (over 3,000 characters) viewed for an average of 15 minutes.” AI output is obtained as priority scores for each category (e.g., economics 0.8, sports 0.6, entertainment 0.4), recommended collection times for each time slot (e.g., 19:00 hour 0.9, 22:00 hour 0.7), and weighting parameters for article length and content tendencies. Output examples include “economics category priority 0.85, recommended collection on weekday evenings,” or “emphasis on long articles.” Based on the AI output priority scores and recommended times, the collection unit controls the collection scheduler and filtering module to automatically optimize the category, content, and timing of articles to be collected. As post-processing, feedback on collection results (e.g., actual browsing rate, user response) is sequentially returned to the AI module, and model parameters can be dynamically updated through reinforcement learning or online learning. As a technical effect, the collection unit, unlike conventional uniform category collection or simple time-of-day specification, analyzes detailed browsing history patterns for each user in high-dimensional feature space and automatically generates optimal collection strategies, greatly improving the efficiency, accuracy, and degree of personalization of information collection. Application fields include personal news aggregation, corporate information sharing, learning history analysis in education, and specialized information collection support in medical and legal fields, among other diverse use cases. In addition, the collection unit is highly extensible, allowing for easy functional expansion through addition of new types of history data (e.g., audio/video browsing history) and integration of multiple AI models (e.g., browsing tendency+emotion estimation), and can flexibly respond to future technological advancements.

The collection unit can perform filtering based on the user's current field of interest when collecting read information. For example, the collection unit prioritizes the collection of read information related to topics in which the user is currently interested. By determining the user's current field of interest and prioritizing the collection of related read information, the collection unit efficiently collects information of interest to the user. For example, if the user shows interest in a specific news category, the collection unit prioritizes the collection of read information in that category. By determining the user's current field of interest and prioritizing the collection of read information in a specific news category when the user shows interest, the collection unit efficiently collects information of interest to the user. For example, the collection unit collects related read information based on keywords recently searched by the user. By determining the user's current field of interest and collecting related read information based on recently searched keywords, the collection unit efficiently collects information of interest to the user. Thus, the collection unit can collect optimal read information based on the user's current field of interest. Specifically, the collection unit aggregates recent search keyword history (e.g., natural language text strings, up to 20 entries), click patterns immediately after article viewing, SNS sharing and comment content, and in-app survey responses obtained from the user's device or application as feature vectors (e.g., category-based interest scores, keyword occurrence frequency vectors). The collection unit inputs these features into a field-of-interest estimation AI module. The AI module uses, for example, a BERT-based natural language understanding model or a multilayer perceptron for category classification to estimate current interest categories (e.g., economics, sports, entertainment, medical, etc.) or topic clusters (e.g., international affairs, AI technology, health management, etc.) from input text and behavior logs. Examples of AI input include “recent search keywords: AI, machine learning, GPU,” “recently viewed articles: 3 economic news, 1 sports article,” or “SNS post: #healthmanagement.” AI output is obtained as interest scores for each category (e.g., economics 0.7, AI technology 0.9, health management 0.6) or estimated topic labels (e.g., ‘AI technology’, ‘health management’). Output examples include “interest category: AI technology (0.92), economics (0.75)” or “topic: health management.” Based on the AI output interest scores and topic labels, the collection unit dynamically sets read information collection filters and prioritizes the collection of article IDs or link URLs related to the relevant categories or topics. As post-processing, user response to collection results (e.g., browsing rate, click rate) is returned to the AI module, and online learning is used to continuously improve the accuracy of field-of-interest estimation. As a technical effect, the collection unit, unlike conventional static category specification or simple keyword matching, accurately estimates real-time changes in the user's field of interest and automatically optimizes the information collection flow, greatly improving the relevance, degree of personalization, and efficiency of information collection. Application fields include personal news readers, corporate information sharing, learning topic management in education, and specialized information collection support in medical and legal fields, among other diverse use cases. In addition, the collection unit is highly extensible, allowing for easy functional expansion through field-of-interest estimation AI version upgrades, addition of new data sources, and integration of multiple AI models (e.g., field-of-interest estimation+emotion estimation), and can flexibly respond to future technological advancements.

The collection unit can estimate the user's emotion and determine the priority of read information to be collected based on the estimated emotion of the user. For example, if the user is excited, the collection unit prioritizes the collection of entertainment-related read information. By estimating the user's emotion and prioritizing the collection of entertainment-related read information when the user is excited, the collection unit efficiently collects information of interest to the user. For example, if the user is calm, the collection unit prioritizes the collection of business-related read information. By estimating the user's emotion and prioritizing the collection of business-related read information when the user is calm, the collection unit efficiently collects information of interest to the user. For example, if the user is tired, the collection unit prioritizes the collection of relaxing read information. By estimating the user's emotion and prioritizing the collection of relaxing read information when the user is tired, the collection unit efficiently collects information of interest to the user. Thus, the collection unit can collect read information with optimal priority according to the user's emotion. Emotion estimation is realized using, for example, an emotion engine or generative AI with emotion estimation functions. Generative AI may be a text generation AI (such as an LLM) or a multimodal generative AI, but is not limited to these examples. Specifically, the collection unit collects multidimensional feature vectors (float arrays, 20 to 100 dimensions) from biometric sensor data obtainable from the user's device (e.g., heart rate, skin conductance, facial images, voice tone), in-app behavior logs (e.g., tap frequency, screen transition speed, input text content), and external environmental information (e.g., calendar events, time, location). The collection unit inputs these feature vectors into an emotion estimation AI module. The emotion estimation AI module uses, for example, a multimodal Transformer architecture (integrating text, images, and voice, with hundreds of millions to billions of parameters), normalizes and embeds the input vectors, and performs emotion classification tasks (e.g., excitement, calmness, fatigue, relaxation). Examples of AI input include “user's voice tone (high-pitched, fast), heart rate 95 bpm, recent input text ‘excited!’” or “smile detected from facial image, free time in calendar, increased tap frequency.” AI output is obtained as emotion labels (e.g., ‘excitement’, ‘calmness’, ‘fatigue’, etc.) and confidence scores (e.g., 0.92, 0.85 as float values). Output examples include “emotion label: excitement, confidence 0.88” or “emotion label: calmness, confidence 0.93.” Based on the AI output emotion label and confidence, the collection unit's priority determination module automatically calculates priority scores for each category of read information (e.g., entertainment 0.9, business 0.7, relaxation 0.8), and controls the collection scheduler and filtering module. As post-processing, user response to collection results (e.g., actual browsing rate, click rate) is sequentially returned to the AI module, and model parameters can be dynamically updated through reinforcement learning or online learning. As a technical effect, the collection unit, unlike conventional uniform category collection or simple rule-based priority determination, accurately estimates the user's real-time emotional state and automatically optimizes the information collection flow, greatly improving the relevance, degree of personalization, and efficiency of information collection. Application fields include personal news aggregation, corporate information sharing, learning history management in education, and specialized information tracking in medical and legal fields, among other diverse use cases. In addition, the collection unit is highly extensible, allowing for easy functional expansion through emotion estimation AI version upgrades, addition of new sensor data, and integration of multiple AI models (e.g., emotion estimation+behavior prediction model), and can flexibly respond to future technological advancements.

The collection unit can prioritize the collection of highly relevant information based on the user's geographic location information when collecting read information. For example, the collection unit prioritizes the collection of news related to the region where the user is currently located. By considering the user's geographic location information and prioritizing the collection of news related to the region where the user is currently located, the collection unit efficiently collects information of interest to the user. For example, if the user is traveling, the collection unit prioritizes the collection of news related to the travel destination. By considering the user's geographic location information and prioritizing the collection of news related to the travel destination when the user is traveling, the collection unit efficiently collects information of interest to the user. For example, if the user is interested in a specific region, the collection unit prioritizes the collection of news related to that region. By considering the user's geographic location information and prioritizing the collection of news related to a specific region when the user is interested, the collection unit efficiently collects information of interest to the user. Thus, the collection unit can collect optimal read information based on the user's geographic location information. Specifically, the collection unit obtains structured data such as latitude and longitude (float-type two-dimensional vector), location acquisition time (ISO8601 format timestamp), and location accuracy (in meters) using GPS or Wi-Fi-based location information APIs from the user's device. The collection unit links this location information with a geographic information system (GIS) database and maps the location information to geographic entity IDs such as prefecture, city, or landmark. Furthermore, the collection unit implements filtering logic to match news article metadata (e.g., article ID, title, category, publication date, related region tags, etc.) with location information and prioritize the collection of news articles related to the user's current location or region of interest. Examples of AI model input include “current location: Chiyoda-ku, Tokyo, acquisition time 2024-06-01T12:00:00Z,” “travel destination: Kita-ku, Osaka, location accuracy 20 m,” or “region of interest: Sapporo, Hokkaido.” The AI model inputs feature vectors such as the user's current location, past movement history, and region of interest history (e.g., list of regions visited in the past week), and calculates geographic relevance scores (e.g., 0.95 for current location, 0.85 for region of interest). AI output is obtained as news article lists with priority scores for each region (e.g., Tokyo-related news priority 0.9, Osaka-related news priority 0.8) or collection recommendation scores (e.g., current location-related news collection recommendation 0.95). Output examples include “priority collection of 10 Tokyo-related news articles” or “recommendation to collect 5 Osaka travel destination news articles.” Based on the AI output priority scores, the collection unit controls the collection scheduler and filtering module to automatically prioritize the collection of geographically relevant news articles. As post-processing, user response to collection results (e.g., browsing rate, click rate for regional news) is returned to the AI module, and online learning is used to continuously improve the accuracy of geographic relevance estimation. As a technical effect, the collection unit, unlike conventional static category collection or simple keyword matching, accurately utilizes the user's real-time geographic location information and automatically optimizes the information collection flow, greatly improving the regional relevance, degree of personalization, and efficiency of information collection. Application fields include local news delivery, local information provision for travelers, emergency notifications by region during disasters, and area marketing support for companies, among other diverse use cases. In addition, the collection unit is highly extensible, allowing for easy functional expansion through addition of new types of location information data (e.g., indoor location, beacon integration) and integration of multiple AI models (e.g., geographic relevance estimation+field-of-interest estimation), and can flexibly respond to future technological advancements.

The collection unit can analyze the user's social media activity and collect related information when collecting read information. For example, the collection unit collects news articles shared by the user on social media. By analyzing the user's social media activity and collecting news articles shared by the user on social media, the collection unit efficiently collects information of interest to the user. For example, the collection unit collects the content of posts from accounts followed by the user on social media. By analyzing the user's social media activity and collecting the content of posts from accounts followed by the user on social media, the collection unit efficiently collects information of interest to the user. For example, the collection unit collects news articles liked by the user on social media. By analyzing the user's social media activity and collecting news articles liked by the user on social media, the collection unit efficiently collects information of interest to the user. Thus, the collection unit can collect optimal read information based on the user's social media activity. Specifically, the collection unit periodically obtains structured data such as public profile, post history, share history, followed account list, like history, and comment history (e.g., post ID, post time, article URL, account ID, action type, text content, etc.) using major social media APIs (e.g., REST API, GraphQL API, etc.). The collection unit stores the obtained data in a user-indexed database (such as a NoSQL document store), and performs deduplication and chronological management to achieve fast and accurate management of social media activity history. Furthermore, the collection unit analyzes post content and shared article URLs using a natural language processing engine to extract news article IDs, categories, and related keywords. Examples of AI model input include “economic news article URL shared at 2024-06-01T10:00:00Z,” “latest post from a medical expert account being followed,” or “list of sports articles liked in the past week.” The AI model inputs the user's social media activity vector (e.g., number of shares, frequency of actions by category, distribution of followed account attributes) and calculates priority scores and collection recommendation scores for related news articles. AI output is obtained as news article lists with priority scores for each action type (e.g., share article priority 0.9, followed post priority 0.8, liked article priority 0.7) or collection recommendation scores (e.g., medical category collection recommendation 0.85). Output examples include “priority collection of 5 shared economic news articles” or “recommendation to collect 3 posts from followed accounts.” Based on the AI output priority scores, the collection unit controls the collection scheduler and filtering module to automatically prioritize the collection of news articles highly related to the user's social media activity. As post-processing, user response to collection results (e.g., browsing rate, click rate for collected articles) is returned to the AI module, and online learning is used to continuously improve the accuracy of relevance estimation. As a technical effect, the collection unit, unlike conventional static category collection or simple keyword matching, accurately analyzes the user's real-time social media activity and automatically optimizes the information collection flow, greatly improving the relevance, degree of personalization, and efficiency of information collection. Application fields include personal news aggregation, information collection for influencers, brand monitoring for companies, and learning topic management in education, among other diverse use cases. In addition, the collection unit is highly extensible, allowing for easy functional expansion through social media API specification changes, addition of new platforms, and integration of multiple AI models (e.g., social activity analysis+field-of-interest estimation), and can flexibly respond to future technological advancements.

The extraction unit can estimate the user's emotion and adjust the criteria for extracting unread topics based on the estimated emotion of the user. For example, if the user is excited, the extraction unit prioritizes the extraction of entertainment-related unread topics. By estimating the user's emotion and prioritizing the extraction of entertainment-related unread topics when the user is excited, the extraction unit efficiently extracts information of interest to the user. For example, if the user is calm, the extraction unit prioritizes the extraction of business-related unread topics. By estimating the user's emotion and prioritizing the extraction of business-related unread topics when the user is calm, the extraction unit efficiently extracts information of interest to the user. For example, if the user is tired, the extraction unit prioritizes the extraction of relaxing unread topics. By estimating the user's emotion and prioritizing the extraction of relaxing unread topics when the user is tired, the extraction unit efficiently extracts information of interest to the user. Thus, the extraction unit can extract unread topics using optimal criteria according to the user's emotion. Emotion estimation is realized using, for example, an emotion engine or generative AI with emotion estimation functions. Generative AI may be a text generation AI (such as an LLM) or a multimodal generative AI, but is not limited to these examples. Specifically, the extraction unit collects multidimensional feature vectors (float arrays, 20 to 100 dimensions) from biometric sensor data obtained from the user's device (e.g., heart rate, skin conductance, facial images, voice tone), in-app behavior logs (e.g., tap frequency, screen transition speed, input text content), and external environmental information (e.g., calendar events, time, location). The extraction unit inputs these feature vectors into an emotion estimation AI module. The emotion estimation AI module uses, for example, a multimodal Transformer architecture (integrating text, images, and voice, with hundreds of millions to billions of parameters), normalizes and embeds the input vectors, and performs emotion classification tasks (e.g., excitement, calmness, fatigue, relaxation). Examples of AI input include “user's voice tone (high-pitched, fast), heart rate 95 bpm, recent input text ‘excited!’” or “smile detected from facial image, free time in calendar, increased tap frequency.” AI output is obtained as emotion labels (e.g., ‘excitement’, ‘calmness’, ‘fatigue’, etc.) and confidence scores (e.g., 0.92, 0.85 as float values). Output examples include “emotion label: excitement, confidence 0.88” or “emotion label: calmness, confidence 0.93.” Based on the AI output emotion label and confidence, the extraction unit's criteria determination module automatically calculates priority scores for each category of unread topics (e.g., entertainment 0.9, business 0.7, relaxation 0.8), and dynamically adjusts extraction algorithm parameters (e.g., category weighting, threshold setting). As post-processing, user response to extraction results (e.g., actual browsing rate, click rate) is sequentially returned to the AI module, and model parameters can be dynamically updated through reinforcement learning or online learning. As a technical effect, the extraction unit, unlike conventional uniform category extraction or simple rule-based criteria determination, accurately estimates the user's real-time emotional state and automatically optimizes the information extraction flow, greatly improving the relevance, degree of personalization, and efficiency of extraction. Application fields include personal news aggregation, corporate information sharing, learning history management in education, and specialized information tracking in medical and legal fields, among other diverse use cases. In addition, the extraction unit is highly extensible, allowing for easy functional expansion through emotion estimation AI version upgrades, addition of new sensor data, and integration of multiple AI models (e.g., emotion estimation+field-of-interest estimation), and can flexibly respond to future technological advancements.

The extraction unit can improve extraction accuracy by considering interrelationships among news articles during extraction. For example, the extraction unit groups related news articles and extracts unread topics. By considering interrelationships among news articles and grouping related news articles, the extraction unit efficiently extracts unread topics. For example, the extraction unit analyzes sources and links of news articles and extracts highly related unread topics. By considering interrelationships among news articles and analyzing sources and links, the extraction unit efficiently extracts highly related unread topics. For example, the extraction unit extracts related unread topics based on common keywords in news articles. By considering interrelationships among news articles and extracting related unread topics based on common keywords, the extraction unit efficiently extracts related unread topics. Thus, by considering interrelationships among news articles, the extraction unit can improve extraction accuracy. Specifically, the extraction unit stores news article metadata (article ID, title, category, publication date, body text, source URL, link URL, keyword list, etc.) in a graph-structured database (e.g., nodes=articles, edges=citation/link relationships), and quantifies relationships among articles using network analysis algorithms (e.g., community detection, clustering, PageRank, etc.). In source and link analysis, the extraction unit uses a natural language processing engine to extract reference expressions and URLs from the body text and constructs a directed graph among articles. Examples of AI model input include “Article A cites Article B and Article C,” or “Articles D and E share the common keyword ‘AI technology.’” The AI model uses a graph neural network (GNN) or Transformer-based relationship extraction model to calculate relationship scores among articles (e.g., 0.95 for strong relationship, 0.7 for moderate relationship) and cluster labels (e.g., international economy cluster, sports cluster, etc.). AI output is obtained as unread article lists with relationship scores or grouped topic clusters. Output examples include “AI technology-related unread article cluster: 5 articles” or “Unread articles in the international economy cluster: 3 articles.” Based on the AI output relationship scores and cluster information, the extraction unit automatically optimizes the extraction priority and group display order of unread topics. As post-processing, user response to extraction results (e.g., cluster-level browsing rate, related topic click rate) is returned to the AI module, and online learning is used to continuously improve relationship extraction accuracy. As a technical effect, the extraction unit, unlike conventional simple list extraction or keyword matching, analyzes complex network structures among articles in high-dimensional space and comprehensively and efficiently extracts highly related topics, greatly improving the comprehensiveness, relevance, and accuracy of extraction. Application fields include time-series news analysis, topic clustering in specialized fields, information propagation analysis during disasters, and competitive information monitoring for companies, among other diverse use cases. In addition, the extraction unit is highly extensible, allowing for easy functional expansion through graph structure extension (e.g., integration with SNS posts, addition of external data sources) and integration of multiple AI models (e.g., relationship extraction+summarization model), and can flexibly respond to future technological advancements.

The extraction unit can apply different extraction algorithms for each category of news articles during extraction. For example, the extraction unit applies an extraction algorithm using emotion analysis to entertainment category news articles. By applying different extraction algorithms for each category of news articles and using emotion analysis for entertainment category news articles, the extraction unit efficiently extracts information of interest to the user. For example, the extraction unit applies an extraction algorithm based on economic indicators to business category news articles. By applying different extraction algorithms for each category of news articles and using economic indicators for business category news articles, the extraction unit efficiently extracts information of interest to the user. For example, the extraction unit applies an extraction algorithm based on match results and player performance to sports category news articles. By applying different extraction algorithms for each category of news articles and using match results and player performance for sports category news articles, the extraction unit efficiently extracts information of interest to the user. Thus, the extraction unit can apply optimal extraction algorithms for each category of news articles. Specifically, the extraction unit analyzes news article metadata (category, title, body, publication date, related indicators, etc.) and selectively applies different AI models or algorithm modules for each category. For example, for the entertainment category, the extraction unit uses a BERT-based emotion analysis model or LSTM-type emotion classifier to calculate emotion scores (e.g., joy 0.8, surprise 0.6) from the article body and prioritizes extraction of articles with high emotional impact. For the business category, the extraction unit extracts economic indicators (e.g., stock price fluctuation rate, exchange rate, earnings announcement date) as feature vectors and calculates importance scores using regression models such as random forest or gradient boosting decision trees. For the sports category, the extraction unit extracts match results (e.g., score, win/loss, player name, record updates) and performance indicators (e.g., scoring rate, number of assists) and estimates attention scores using rule-based or neural network methods. Examples of AI input include “entertainment article body (2,000 characters), category: entertainment,” “business article body+stock price fluctuation rate+earnings announcement date,” or “sports article body+match score+player name.” AI output is obtained as priority scores or extraction recommendation scores for each category (e.g., entertainment 0.85, business 0.9, sports 0.8). Output examples include “3 entertainment articles with high emotional impact,” “2 business articles immediately after earnings announcement,” or “5 sports articles related to the final match.” Based on the AI output scores and recommendations, the extraction unit automatically optimizes the generation of extraction lists and display order. As post-processing, user response to extraction results (e.g., category-based browsing rate, click rate) is returned to the AI module, and online learning is used to continuously improve extraction accuracy. As a technical effect, the extraction unit, unlike conventional uniform extraction or simple keyword matching, applies advanced AI algorithms tailored to category characteristics, greatly improving the relevance, degree of personalization, and accuracy of extraction. Application fields include personal news readers, information extraction in specialized fields, industry trend analysis for companies, and breaking news delivery for sports fans, among other diverse use cases. In addition, the extraction unit is highly extensible, allowing for easy functional expansion through category addition, AI model version upgrades, and integration of multiple models (e.g., emotion analysis+summarization model), and can flexibly respond to future technological advancements.

The extraction unit can estimate the user's emotion and determine the priority of topics to be extracted based on the estimated emotion of the user. For example, if the user is excited, the extraction unit prioritizes the extraction of entertainment-related topics. By estimating the user's emotion and prioritizing the extraction of entertainment-related topics when the user is excited, the extraction unit efficiently extracts information of interest to the user. For example, if the user is calm, the extraction unit prioritizes the extraction of business-related topics. By estimating the user's emotion and prioritizing the extraction of business-related topics when the user is calm, the extraction unit efficiently extracts information of interest to the user. For example, if the user is tired, the extraction unit prioritizes the extraction of relaxing topics. By estimating the user's emotion and prioritizing the extraction of relaxing topics when the user is tired, the extraction unit efficiently extracts information of interest to the user. Thus, the extraction unit can extract topics with optimal priority according to the user's emotion. Emotion estimation is realized using, for example, an emotion engine or generative AI with emotion estimation functions. Generative AI may be a text generation AI (such as an LLM) or a multimodal generative AI, but is not limited to these examples. Specifically, the extraction unit collects multidimensional feature vectors (float arrays, 20 to 100 dimensions) from biometric sensor data obtained from the user's device (e.g., heart rate, skin conductance, facial images, voice tone), in-app behavior logs (e.g., tap frequency, screen transition speed, input text content), and external environmental information (e.g., calendar events, time, location). The extraction unit inputs these feature vectors into an emotion estimation AI module. The emotion estimation AI module uses, for example, a multimodal Transformer architecture (integrating text, images, and voice, with hundreds of millions to billions of parameters), normalizes and embeds the input vectors, and performs emotion classification tasks (e.g., excitement, calmness, fatigue, relaxation). Examples of AI input include “user's voice tone (high-pitched, fast), heart rate 95 bpm, recent input text ‘excited!’” or “smile detected from facial image, free time in calendar, increased tap frequency.” AI output is obtained as emotion labels (e.g., ‘excitement’, ‘calmness’, ‘fatigue’, etc.) and confidence scores (e.g., 0.92, 0.85 as float values). Output examples include “emotion label: excitement, confidence 0.88” or “emotion label: calmness, confidence 0.93.” Based on the AI output emotion label and confidence, the extraction unit automatically calculates priority scores for each topic category (e.g., entertainment 0.9, business 0.7, relaxation 0.8), and dynamically optimizes the order and display sequence of extraction lists. As post-processing, user response to extraction results (e.g., category-based browsing rate, click rate) is returned to the AI module, and model parameters can be dynamically updated through reinforcement learning or online learning. As a technical effect, the extraction unit, unlike conventional uniform category extraction or simple rule-based priority determination, accurately estimates the user's real-time emotional state and automatically optimizes the information extraction flow, greatly improving the relevance, degree of personalization, and efficiency of extraction. Application fields include personal news aggregation, corporate information sharing, learning history management in education, and specialized information tracking in medical and legal fields, among other diverse use cases. In addition, the extraction unit is highly extensible, allowing for easy functional expansion through emotion estimation AI version upgrades, addition of new sensor data, and integration of multiple AI models (e.g., emotion estimation+field-of-interest estimation), and can flexibly respond to future technological advancements.

The extraction unit can perform extraction based on the geographic distribution of news articles during extraction. For example, the extraction unit prioritizes the extraction of news articles related to the region where the user is currently located. By considering the geographic distribution of news articles and prioritizing the extraction of news articles related to the region where the user is currently located, the extraction unit efficiently extracts information of interest to the user. For example, if the user is traveling, the extraction unit prioritizes the extraction of news articles related to the travel destination. By considering the geographic distribution of news articles and prioritizing the extraction of news articles related to the travel destination when the user is traveling, the extraction unit efficiently extracts information of interest to the user. For example, if the user is interested in a specific region, the extraction unit prioritizes the extraction of news articles related to that region. By considering the geographic distribution of news articles and prioritizing the extraction of news articles related to a specific region when the user is interested, the extraction unit efficiently extracts information of interest to the user. Thus, by considering the geographic distribution of news articles, the extraction unit can improve extraction accuracy. Specifically, the extraction unit obtains structured data such as latitude and longitude (float-type two-dimensional vector), location acquisition time (ISO8601 format timestamp), and location accuracy (in meters) using GPS or Wi-Fi-based location information APIs from the user's device. The extraction unit links this location information with a geographic information system (GIS) database and maps the location information to geographic entity IDs such as prefecture, city, or landmark. Furthermore, the extraction unit implements filtering logic to match news article metadata (e.g., article ID, title, category, publication date, related region tags, etc.) with location information and prioritize the extraction of news articles related to the user's current location or region of interest. Examples of AI model input include “current location: Chiyoda-ku, Tokyo, acquisition time 2024-06-01T12:00:00Z,” “travel destination: Kita-ku, Osaka, location accuracy 20 m,” or “region of interest: Sapporo, Hokkaido.” The AI model inputs feature vectors such as the user's current location, past movement history, and region of interest history (e.g., list of regions visited in the past week), and calculates geographic relevance scores (e.g., 0.95 for current location, 0.85 for region of interest). AI output is obtained as news article lists with priority scores for each region (e.g., Tokyo-related news priority 0.9, Osaka-related news priority 0.8) or extraction recommendation scores (e.g., current location-related news extraction recommendation 0.95). Output examples include “priority extraction of 10 Tokyo-related news articles” or “recommendation to extract 5 Osaka travel destination news articles.” Based on the AI output priority scores, the extraction unit controls the extraction scheduler and filtering module to automatically prioritize the extraction of geographically relevant news articles. As post-processing, user response to extraction results (e.g., browsing rate, click rate for regional news) is returned to the AI module, and online learning is used to continuously improve the accuracy of geographic relevance estimation. As a technical effect, the extraction unit, unlike conventional static category extraction or simple keyword matching, accurately utilizes the user's real-time geographic location information and automatically optimizes the information extraction flow, greatly improving the regional relevance, degree of personalization, and efficiency of extraction. Application fields include local news delivery, local information provision for travelers, emergency notifications by region during disasters, and area marketing support for companies, among other diverse use cases. In addition, the extraction unit is highly extensible, allowing for easy functional expansion through addition of new types of location information data (e.g., indoor location, beacon integration) and integration of multiple AI models (e.g., geographic relevance estimation+field-of-interest estimation), and can flexibly respond to future technological advancements.

The extraction unit can improve extraction accuracy by referring to related literature of news articles during extraction. For example, the extraction unit analyzes sources and links of news articles and extracts highly related unread topics. By referring to related literature of news articles and analyzing sources and links, the extraction unit efficiently extracts highly related unread topics. For example, the extraction unit extracts related unread topics based on common keywords in news articles. By referring to related literature of news articles and extracting related unread topics based on common keywords, the extraction unit efficiently extracts related unread topics. For example, the extraction unit refers to related literature of news articles to improve extraction accuracy. By referring to related literature of news articles and analyzing sources and links, the extraction unit efficiently extracts highly related unread topics. Thus, by referring to related literature of news articles, the extraction unit can improve extraction accuracy. Specifically, the extraction unit stores news article metadata (article ID, title, category, publication date, body text, source URL, link URL, keyword list, etc.) in a graph-structured database (nodes=articles, edges=citation/link/common keyword relationships), and quantifies relationships among articles using network analysis algorithms (e.g., clustering, community detection, PageRank, etc.). In source and link analysis, the extraction unit uses a natural language processing engine to extract reference expressions and URLs from the body text and constructs a directed graph among articles. Examples of AI model input include “Article A cites Article B and Article C,” “Articles D and E share the common keyword ‘AI technology,’” or “Article F refers to external paper G.” The AI model uses a graph neural network (GNN) or Transformer-based relationship extraction model to calculate relationship scores among articles (e.g., 0.95 for strong relationship, 0.7 for moderate relationship) and cluster labels (e.g., AI technology cluster, international economy cluster, etc.). AI output is obtained as unread article lists with relationship scores or grouped topic clusters. Output examples include “AI technology-related unread article cluster: 5 articles” or “Unread articles in the international economy cluster: 3 articles.” Based on the AI output relationship scores and cluster information, the extraction unit automatically optimizes the extraction priority and group display order of unread topics. As post-processing, user response to extraction results (e.g., cluster-level browsing rate, related topic click rate) is returned to the AI module, and online learning is used to continuously improve relationship extraction accuracy. As a technical effect, the extraction unit, unlike conventional simple list extraction or keyword matching, analyzes complex network structures among articles and relationships with external literature in high-dimensional space and comprehensively and efficiently extracts highly related topics, greatly improving the comprehensiveness, relevance, and accuracy of extraction. Application fields include time-series news analysis, topic clustering in specialized fields, information propagation analysis during disasters, competitive information monitoring for companies, and citation network analysis of academic papers, among other diverse use cases. In addition, the extraction unit is highly extensible, allowing for easy functional expansion through graph structure extension (e.g., integration with SNS posts, addition of external data sources) and integration of multiple AI models (e.g., relationship extraction+summarization model), and can flexibly respond to future technological advancements.

The summarization unit can estimate the user's emotion and adjust the expression method of the summary based on the estimated emotion of the user. For example, if the user is relaxed, the summarization unit provides a detailed summary. By estimating the user's emotion and providing a detailed summary when the user is relaxed, the summarization unit enables the user to efficiently obtain information of interest. For example, if the user is in a hurry, the summarization unit provides a concise summary. By estimating the user's emotion and providing a concise summary when the user is in a hurry, the summarization unit enables the user to efficiently obtain information of interest. For example, if the user is excited, the summarization unit provides a summary including visually stimulating expressions. By estimating the user's emotion and providing a summary including visually stimulating expressions when the user is excited, the summarization unit enables the user to efficiently obtain information of interest. Thus, the summarization unit can provide summaries in the optimal expression method according to the user's emotion. Emotion estimation is realized using, for example, an emotion engine or generative AI with emotion estimation functions. Generative AI may be a text generation AI (such as an LLM) or a multimodal generative AI, but is not limited to these examples. Specifically, the summarization unit collects multidimensional feature vectors (float arrays, 20 to 100 dimensions) from biometric sensor data obtained from the user's device (e.g., heart rate, skin conductance, facial images, voice tone), in-app behavior logs (e.g., tap frequency, screen transition speed, input text content), and external environmental information (e.g., calendar events, time, location). The summarization unit inputs these feature vectors into an emotion estimation AI module, which uses, for example, a multimodal Transformer architecture (integrating text, images, and voice, with hundreds of millions to billions of parameters) to perform emotion classification tasks (e.g., relaxation, hurry, excitement, tension, fatigue). Examples of AI input include “user's voice tone (calm), heart rate 65 bpm, recent input text ‘I can read slowly’” or “smile detected from facial image, free time in calendar, decreased tap frequency.” AI output is obtained as emotion labels (e.g., ‘relaxation’, ‘hurry’, ‘excitement’, etc.) and confidence scores (e.g., 0.92, 0.85 as float values). Output examples include “emotion label: relaxation, confidence 0.88” or “emotion label: hurry, confidence 0.93.” Based on the AI output emotion label and confidence, the summarization unit dynamically adjusts the parameters of the summary generation AI module (e.g., summary length, level of detail, expression style, inclusion of visual elements). For example, in a relaxed state, the summary length is set to 400 to 600 characters, including detailed explanations and supplementary information. In a hurry, the summary length is limited to 100 to 200 characters, extracting only bullet points or key points. In an excited state, colorful icons, emojis, and emphasis expressions (e.g., bold, highlight) are automatically inserted into the summary text. Examples of summary generation AI input include “economic news body (3,000 characters), emotion label: relaxation” or “sports breaking news body (2,000 characters), emotion label: hurry.” Examples of AI summary output include “Detailed summary: An agreement was reached between Country A and Country B at the international economic summit, with the main topics being energy policy and trade agreements. The background and future outlook are also explained” or “Concise summary: Player X won, and the final match was closely contested.” As post-processing, user response to summary output (e.g., completion rate, reread rate, summary evaluation score) is returned to the AI module, and online learning is used to continuously improve the accuracy of summary expression optimization. As a technical effect, the summarization unit, unlike conventional uniform summaries or static expression styles, accurately estimates the user's real-time emotional state and automatically optimizes the summary generation flow, greatly improving information receptivity, degree of personalization, and efficiency of understanding. Application fields include personal news readers, learning summaries in education, specialized information digests in medical and legal fields, and breaking news delivery in entertainment, among other diverse use cases. In addition, the summarization unit is highly extensible, allowing for easy functional expansion through emotion estimation AI and summary generation AI version upgrades, addition of new emotion labels, and integration of multiple AI models (e.g., emotion estimation+summary generation+visual expression generation), and can flexibly respond to future technological advancements.

The summarization unit can adjust the level of detail of a summary based on the importance of news articles during summary generation. For example, the summarization unit provides a detailed summary for news articles with high importance. By evaluating the importance of news articles and providing detailed summaries for highly important articles, the summarization unit enables users to efficiently obtain information of interest. For news articles with low importance, the summarization unit provides concise summaries. By evaluating the importance of news articles and providing concise summaries for articles with low importance, the summarization unit enables users to efficiently obtain information of interest. The summarization unit can also adjust the length of the summary according to the importance of the news article. By evaluating the importance of news articles and adjusting the summary length accordingly, the summarization unit enables users to efficiently obtain information of interest. Thus, the summarization unit can provide summaries at an optimal level of detail according to the importance of news articles. Specifically, the summarization unit acquires news article metadata (e.g., article ID, title, category, publication date, body text, number of views, number of SNS shares, editorial evaluation score, etc.) as input data. The summarization unit inputs this metadata into an importance estimation AI module, and, for example, uses gradient boosting decision trees or multilayer perceptrons to calculate an importance score for each article (e.g., a float value from 0.0 to 1.0). Examples of AI input include “Article title: International Economic Summit, Category: Economy, Views: 10,000, SNS Shares: 500, Editorial Evaluation: High” or “Article title: Local Event, Category: Local, Views: 200, SNS Shares: 10, Editorial Evaluation: Low”. The AI output is obtained as an importance score (e.g., 0.95 for high importance, 0.3 for low importance). Examples of output include “Importance score: 0.92” or “Importance score: 0.35”. Based on the importance score output by the AI, the summarization unit dynamically adjusts the parameters of the summary generation AI module (e.g., summary length, level of detail, inclusion of explanatory supplements). For example, if the importance score is 0.8 or higher, the summary length is set to 400-600 characters, and a detailed summary including background information and future outlook is generated. If the importance score is below 0.5, the summary length is limited to 100-200 characters, and only the main points are extracted. Examples of summary generation AI input include “Economic news body (3,000 characters), importance score 0.92” or “Local event article body (1,500 characters), importance score 0.35”. Examples of AI summary output include “Detailed summary: At the International Economic Summit, an agreement was reached between Country A and Country B, with main topics being energy policy and trade agreements. Background and future outlook are also explained” or “Concise summary: A local event was held”. As a subsequent process, user reactions to the summary output (e.g., completion rate, summary evaluation score) can be fed back to the AI module to continuously improve the accuracy of importance estimation and summary generation through online learning. As a technical effect, the summarization unit, unlike conventional uniform summaries or static detail settings, can highly accurately estimate the real-time importance of news articles and automatically optimize the summary generation flow, thereby greatly improving the comprehensiveness, personalization, and efficiency of understanding of information. Application fields include news distribution requiring immediacy, important information digests in specialized fields, industry trend analysis for companies, emergency information summarization during disasters, and various other use cases. Furthermore, the summarization unit is highly extensible, allowing for easy upgrades of the importance estimation AI and summary generation AI, addition of new importance indicators, and functional expansion through collaboration of multiple AI models (e.g., importance estimation+summary generation+emotion analysis), enabling flexible adaptation to future technological evolution.

The summarization unit can apply different summarization algorithms according to the category of news articles during summary generation. For example, for news articles in the entertainment category, the summarization unit applies a summarization algorithm using emotion analysis. By applying different summarization algorithms for each news article category and using emotion analysis for entertainment category articles, the summarization unit efficiently summarizes information of interest to the user. For business category news articles, the summarization unit applies a summarization algorithm based on economic indicators. By applying different summarization algorithms for each news article category and using economic indicators for business category articles, the summarization unit efficiently summarizes information of interest to the user. For sports category news articles, the summarization unit applies a summarization algorithm based on match results and player performance. By applying different summarization algorithms for each news article category and using match results and player performance for sports category articles, the summarization unit efficiently summarizes information of interest to the user. Thus, the summarization unit can apply optimal summarization algorithms for each news article category. Specifically, the summarization unit analyzes news article metadata (category, title, body, publication date, related indicators, etc.) and selectively applies different AI models or algorithm modules for each category. For example, in the entertainment category, BERT-based emotion analysis models or LSTM-type emotion classifiers are used to calculate emotion scores (e.g., joy 0.8, surprise 0.6, etc.) from the article body, and highly emotional parts are reflected in the summary text. In the business category, economic indicators (e.g., stock price fluctuation rate, exchange rate, earnings announcement date, etc.) are extracted as feature vectors, and regression models such as random forest or gradient boosting decision trees are used to calculate importance scores, incorporating numerical information and trend explanations into the summary text. In the sports category, match results (e.g., score, win/loss, player names, record updates, etc.) and performance indicators (e.g., scoring rate, number of assists, etc.) are extracted, and attention estimation is performed using rule-based or neural network methods, reflecting major match results and player achievements in the summary text. Examples of AI input include “Entertainment article body (2,000 characters), category: entertainment”, “Business article body+stock price fluctuation rate+earnings announcement date”, “Sports article body+match score+player name”, etc. The AI output is obtained as category-specific summary texts (e.g., emotion impact-focused summary, summary with economic indicator explanations, match result summary). Examples of output include “High emotional impact: The featured movie was a big hit, audience reactions were surprise and emotion”, “Earnings announcement: Company A's sales increased by 10% year-on-year, stock price is on an upward trend”, “Final match: Player X scored two goals to win the championship”, etc. The summarization unit automatically applies category-specific post-processing (e.g., emphasizing emotional expressions, graphing numerical data, highlighting player names) to the AI output summary text. As a subsequent process, user reactions to the summary output (e.g., category-specific viewing rate, summary evaluation score) can be fed back to the AI module to continuously improve category-specific summarization accuracy through online learning. As a technical effect, the summarization unit, unlike conventional uniform summaries or simple keyword extraction, applies advanced AI algorithms tailored to category characteristics, greatly improving information relevance, personalization, and summarization accuracy. Application fields include personal news readers, information summarization in specialized fields, industry trend analysis for companies, and real-time distribution for sports fans, among various other use cases. Furthermore, the summarization unit is highly extensible, allowing for easy addition of categories, AI model upgrades, and functional expansion through collaboration of multiple models (e.g., emotion analysis+summary generation+numerical analysis), enabling flexible adaptation to future technological evolution.

The summarization unit can estimate the user's emotion and adjust the length of the summary based on the estimated emotion. For example, when the user is in a hurry, the summarization unit provides a short summary that covers the main points. By estimating the user's emotion and providing a short, focused summary when the user is in a hurry, the summarization unit enables the user to efficiently obtain information of interest. When the user is relaxed, the summarization unit provides a longer summary with detailed explanations. By estimating the user's emotion and providing a longer summary with detailed explanations when the user is relaxed, the summarization unit enables the user to efficiently obtain information of interest. When the user is excited, the summarization unit provides a summary with visually stimulating expressions. By estimating the user's emotion and providing a summary with visually stimulating expressions when the user is excited, the summarization unit enables the user to efficiently obtain information of interest. Thus, the summarization unit can provide summaries at an optimal length according to the user's emotion. Emotion estimation is realized, for example, by using an emotion engine or generative AI with emotion estimation functions. Generative AI may include text generation AI (e.g., LLM) or multimodal generative AI, but is not limited to these examples. Specifically, the summarization unit collects multidimensional feature vectors (float arrays, 20-100 dimensions) from biometric sensor data obtained from the user terminal (e.g., heart rate, skin conductance response, facial images, voice tone), in-app behavior logs (e.g., tap frequency, screen transition speed, input text content), and external environmental information (e.g., calendar events, time, location information). These feature vectors are input into an emotion estimation AI module, which, for example, uses a multimodal Transformer architecture (integrating text, image, and voice, with hundreds of millions to billions of parameters) to perform emotion classification tasks (e.g., labels such as relaxed, in a hurry, excited, tense, fatigued, etc.). Examples of AI input include “User's voice tone (fast), heart rate 95 bpm, recent input text ‘in a hurry’” or “Smile detected from facial image, free time in calendar, decreased tap frequency”. The AI output is obtained as emotion labels (e.g., ‘relaxed’, ‘in a hurry’, ‘excited’, etc.) and confidence scores (e.g., float values such as 0.92, 0.85). Examples of output include “Emotion label: in a hurry, confidence 0.93” or “Emotion label: relaxed, confidence 0.88”. Based on the AI output emotion label and confidence, the summarization unit dynamically adjusts the parameters of the summary generation AI module (e.g., summary length, level of detail, expression style). For example, in a hurried state, the summary length is limited to 100-200 characters, and only the main points are extracted. In a relaxed state, the summary length is set to 400-600 characters, including detailed explanations and supplementary information. In an excited state, colorful icons, emojis, and emphasis (e.g., bold, highlight) are automatically inserted into the summary text. Examples of summary generation AI input include “Economic news body (3,000 characters), emotion label: relaxed” or “Sports news body (2,000 characters), emotion label: in a hurry”. Examples of AI summary output include “Detailed summary: At the International Economic Summit, an agreement was reached between Country A and Country B, with main topics being energy policy and trade agreements. Background and future outlook are also explained” or “Concise summary: Player X won the championship, the final match was close”. As a subsequent process, user reactions to the summary output (e.g., completion rate, reread rate, summary evaluation score) can be fed back to the AI module to continuously improve the accuracy of summary length optimization through online learning. As a technical effect, the summarization unit, unlike conventional uniform summary lengths or static expression styles, can highly accurately estimate the user's real-time emotional state and automatically optimize the summary generation flow, thereby greatly improving information receptivity, personalization, and efficiency of understanding. Application fields include personal news readers, educational learning summaries, specialized information digests in medical and legal fields, and real-time distribution in entertainment, among various other use cases. Furthermore, the summarization unit is highly extensible, allowing for easy upgrades of emotion estimation AI and summary generation AI, addition of new emotion labels, and functional expansion through collaboration of multiple AI models (e.g., emotion estimation+summary generation+visual expression generation), enabling flexible adaptation to future technological evolution.

The summarization unit can determine the priority of summaries based on the submission timing of news articles during summary generation. For example, the summarization unit prioritizes summarizing the latest news articles. By considering the submission timing of news articles and prioritizing the latest articles, the summarization unit enables users to efficiently obtain information of interest. For older news articles, the summarization unit provides concise summaries. By considering the submission timing and providing concise summaries for older articles, the summarization unit enables users to efficiently obtain information of interest. The summarization unit can also adjust the level of detail of summaries according to the submission timing. By considering the submission timing and adjusting the level of detail accordingly, the summarization unit enables users to efficiently obtain information of interest. Thus, the summarization unit can provide summaries at an optimal priority according to the submission timing of news articles. Specifically, the summarization unit acquires news article metadata (e.g., article ID, title, category, publication date, submission time, body text, etc.) as input data. This metadata is input into a time-series priority estimation AI module, which, for example, uses time-series convolutional neural networks (TCN) or LSTM-type recurrent neural networks to calculate a time-series priority score for each article (e.g., a float value from 0.0 to 1.0). Examples of AI input include “Article title: International Economic Summit, publication date: 2024-06-01T10:00:00Z” or “Article title: Local Event, publication date: 2024-05-20T08:00:00Z”. The AI output is obtained as a time-series priority score (e.g., 0.95 for latest articles, 0.3 for older articles). Examples of output include “Time-series priority score: 0.92” or “Time-series priority score: 0.35”. Based on the AI output time-series priority score, the summarization unit dynamically adjusts the parameters of the summary generation AI module (e.g., summary generation order, summary length, level of detail). For example, if the time-series priority score is 0.8 or higher, the summary generation order is set to highest priority, and a detailed summary (400-600 characters) is generated. If the score is below 0.5, the summary generation order is delayed, and a concise summary (100-200 characters) is generated. Examples of summary generation AI input include “Economic news body (3,000 characters), time-series priority score 0.92” or “Local event article body (1,500 characters), time-series priority score 0.35”. Examples of AI summary output include “Detailed summary: At the International Economic Summit, an agreement was reached between Country A and Country B, with main topics being energy policy and trade agreements. Background and future outlook are also explained” or “Concise summary: A local event was held”. As a subsequent process, user reactions to the summary output (e.g., completion rate, summary evaluation score) can be fed back to the AI module to continuously improve the accuracy of time-series priority estimation and summary generation through online learning. As a technical effect, the summarization unit, unlike conventional uniform summaries or static priority settings, can highly accurately estimate the real-time submission timing of news articles and automatically optimize the summary generation flow, thereby greatly improving the immediacy, personalization, and efficiency of understanding of information. Application fields include news distribution requiring immediacy, time-series information digests in specialized fields, industry trend analysis for companies, emergency information summarization during disasters, and various other use cases. Furthermore, the summarization unit is highly extensible, allowing for easy upgrades of time-series priority estimation AI and summary generation AI, addition of new time-series indicators, and functional expansion through collaboration of multiple AI models (e.g., time-series estimation+summary generation+emotion analysis), enabling flexible adaptation to future technological evolution.

The summarization unit can adjust the order of summaries based on the relevance of news articles during summary generation. For example, the summarization unit prioritizes summarizing highly relevant news articles. By evaluating the relevance of news articles and prioritizing highly relevant articles, the summarization unit enables users to efficiently obtain information of interest. For news articles with low relevance, the summarization unit provides concise summaries. By evaluating the relevance of news articles and providing concise summaries for articles with low relevance, the summarization unit enables users to efficiently obtain information of interest. The summarization unit can also adjust the order of summaries according to the relevance of news articles. By evaluating the relevance and adjusting the order accordingly, the summarization unit enables users to efficiently obtain information of interest. Thus, the summarization unit can provide summaries in an optimal order according to the relevance of news articles. Specifically, the summarization unit stores news article metadata (article ID, title, category, publication date, body text, source URL, destination URL, keyword list, etc.) in a graph-structured database (nodes=articles, edges=citation/link/common keyword relationships) and quantifies inter-article relationships using network analysis algorithms (e.g., clustering, community detection, PageRank, etc.). In analyzing sources and links, the summarization unit uses a natural language processing engine to extract reference expressions and URLs from the body text and constructs a directed graph among articles. Examples of AI model input include “Article A cites Article B and Article C”, “Articles D and E share the keyword ‘AI technology’”, “Article F refers to external paper G”, etc. The AI model uses graph neural networks (GNN) or Transformer-based relation extraction models to calculate inter-article relevance scores (e.g., 0.95 for strong relevance, 0.7 for moderate relevance) and cluster labels (e.g., AI technology cluster, international economy cluster, etc.). The AI output is obtained as a summary generation order list with relevance scores or as grouped topic clusters. Examples of output include “AI technology-related summary cluster: 5 items”, “3 summaries in the international economy cluster”, etc. Based on the AI output relevance scores and cluster information, the summarization unit automatically optimizes the summary generation order and display order. Highly relevant articles are summarized in detail first, while articles with low relevance are summarized concisely later. As a subsequent process, user reactions to the summary output (e.g., cluster-level viewing rate, click rate on related topics) can be fed back to the AI module to continuously improve the accuracy of relation extraction and summary order optimization through online learning. As a technical effect, the summarization unit, unlike conventional simple list summaries or keyword matching, analyzes complex network structures among articles and relationships with external literature in high-dimensional space, enabling comprehensive and efficient summarization of highly relevant topics, thereby greatly improving information comprehensiveness, relevance, and summarization accuracy. Application fields include time-series news analysis, topic clustering in specialized fields, information propagation analysis during disasters, competitive information monitoring for companies, citation network summarization for academic papers, and various other use cases. Furthermore, the summarization unit is highly extensible, allowing for easy expansion of graph structures (e.g., integration with SNS posts, addition of external data sources) and functional expansion through collaboration of multiple AI models (e.g., relation extraction+summary generation), enabling flexible adaptation to future technological evolution.

The provision unit can estimate the user's emotion and adjust the method of providing information based on the estimated emotion. For example, when the user is tense, the provision unit provides information in a calm tone. By estimating the user's emotion and providing information in a calm tone when the user is tense, the provision unit makes it easier for the user to receive information. When the user is relaxed, the provision unit provides information in a bright tone. By estimating the user's emotion and providing information in a bright tone when the user is relaxed, the provision unit makes it easier for the user to receive information. When the user is in a hurry, the provision unit provides information quickly and concisely. By estimating the user's emotion and providing information quickly and concisely when the user is in a hurry, the provision unit makes it easier for the user to receive information. Thus, the provision unit can provide information in an optimal manner according to the user's emotion. Emotion estimation is realized, for example, by using an emotion engine or generative AI with emotion estimation functions. Generative AI may include text generation AI (e.g., LLM) or multimodal generative AI, but is not limited to these examples. Specifically, the provision unit collects multidimensional feature vectors (float arrays, 20-100 dimensions) from biometric sensor data obtained from the user terminal (e.g., heart rate, skin conductance response, facial images, voice tone), in-app behavior logs (e.g., tap frequency, screen transition speed, input text content), and external environmental information (e.g., calendar events, time, location information). These feature vectors are input into an emotion estimation AI module. The emotion estimation AI module, for example, uses a multimodal Transformer architecture (integrating text, image, and voice, with hundreds of millions to billions of parameters) to normalize and embed the input vectors and perform emotion classification tasks (e.g., labels such as tense, relaxed, in a hurry, excited, fatigued, etc.). Examples of AI input include “User's voice tone (low and slow), heart rate 110 bpm, recent input text ‘tense’” or “Smile detected from facial image, free time in calendar, decreased tap frequency”. The AI output is obtained as emotion labels (e.g., ‘tense’, ‘relaxed’, ‘in a hurry’, etc.) and confidence scores (e.g., float values such as 0.92, 0.85). Examples of output include “Emotion label: tense, confidence 0.91” or “Emotion label: relaxed, confidence 0.88”. Based on the AI output emotion label and confidence, the provision unit dynamically adjusts the parameters of the information provision module (e.g., tone setting, expression style, amount of information, notification method). For example, in a tense state, color and voice tone are set to calm, and redundant information is eliminated to convey only the main points. In a relaxed state, bright colors and friendly expressions are used, and detailed supplementary information or illustrations are added. In a hurried state, notification sounds or vibrations are emphasized, and information is displayed immediately in concise text of about 100-200 characters. Examples of information provision generation AI input include “Summary text (300 characters), emotion label: tense” or “Summary text (500 characters), emotion label: relaxed”. Examples of AI output include “Calm tone voice reading+simple text display” or “Bright color banner+detailed explanation”. The provision unit automatically optimizes notification methods (e.g., push notifications, voice reading, banner display) and expression styles (e.g., color, font, icon insertion) according to the user's emotional state. As a subsequent process, user reactions after information provision (e.g., completion rate, re-notification requests, evaluation score) can be fed back to the AI module to continuously improve the accuracy of information provision optimization through online learning. As a technical effect, the provision unit, unlike conventional uniform notifications or static expression styles, can highly accurately estimate the user's real-time emotional state and automatically optimize the information provision flow, thereby greatly improving information receptivity, personalization, and efficiency of understanding. Application fields include personal news readers, educational learning notifications, specialized information alerts in medical and legal fields, and real-time distribution in entertainment, among various other use cases. Furthermore, the provision unit is highly extensible, allowing for easy upgrades of emotion estimation AI and information provision generation AI, addition of new emotion labels, and functional expansion through collaboration of multiple AI models (e.g., emotion estimation+information provision+visual expression generation), enabling flexible adaptation to future technological evolution.

The provision unit can select the method of providing information based on the user's past browsing history at the time of information provision. For example, the provision unit prioritizes providing related information based on news categories that the user has frequently viewed in the past. By referring to the user's past browsing history and prioritizing related information based on frequently viewed news categories, the provision unit efficiently provides information of interest to the user. The provision unit can also analyze the tendency of articles that the user has spent a long time viewing in the past and prioritize providing similar content. By referring to the user's past browsing history and analyzing the tendency of articles viewed for a long time, the provision unit efficiently provides information of interest to the user. If the user tends to browse at specific times of day, the provision unit provides information at those times. By referring to the user's past browsing history and providing information at times when the user tends to browse, the provision unit efficiently provides information of interest to the user. Thus, the provision unit can provide information in an optimal manner based on the user's past browsing history. Specifically, the provision unit periodically acquires structured data such as article ID, category, browsing start/end time, browsing duration (in seconds), article title, body length, device type, and source application from a user-indexed browsing history database (e.g., NoSQL document store, RDBMS). These history data are aggregated as feature vectors (e.g., category-wise browsing frequency vector, time-of-day access histogram, article length distribution, etc.) and input into a user profile generation AI module. The AI module, for example, uses time-series convolutional neural networks (TCN) or LSTM-type recurrent neural networks to analyze browsing patterns over the past 30 days (e.g., a 720-dimensional time-series vector for 24 hours×30 days). Examples of AI input include “Category-wise browsing counts over the past 30 days (e.g., Economy 50 times, Sports 30 times, Entertainment 20 times)”, “Access concentrated on weekdays from 19:00 to 22:00”, “Long articles (over 3,000 characters) viewed for an average of 15 minutes”, etc. The AI output is obtained as category-wise priority scores (e.g., Economy 0.8, Sports 0.6, Entertainment 0.4), recommended provision times by time slot (e.g., 19:00 slot 0.9, 22:00 slot 0.7), and weighting parameters for article length/content tendency. Examples of output include “Economy category priority 0.85, recommended provision on weekday evenings”, “Emphasis on long articles”, etc. Based on the AI output priority scores and recommended time slots, the provision unit controls the information provision scheduler and filtering module to automatically optimize the category, content, and timing of articles to be provided. As a subsequent process, feedback on provision results (e.g., actual viewing rate, user reaction) can be sequentially sent to the AI module, and model parameters can be dynamically updated through reinforcement learning or online learning. As a technical effect, the provision unit, unlike conventional uniform category provision or simple time slot specification, analyzes detailed browsing history patterns for each user in high-dimensional feature space and automatically generates optimal information provision strategies, thereby greatly improving the efficiency, accuracy, and personalization of information provision. Application fields include personal news aggregation, corporate information sharing, learning history analysis in education, and support for specialized information provision in medical and legal fields, among various other use cases. Furthermore, the provision unit is highly extensible, allowing for easy addition of history data types (e.g., voice/video browsing history) and functional expansion through collaboration of multiple AI models (e.g., browsing tendency+emotion estimation), enabling flexible adaptation to future technological evolution.

The provision unit can customize the means of provision based on the user's current living situation at the time of information provision. For example, when the user is commuting, the provision unit provides information via audio. By considering the user's current living situation and providing information via audio during commuting, the provision unit makes it easier for the user to receive information. When the user is relaxing at home, the provision unit provides information visually. By considering the user's current living situation and providing information visually when the user is relaxing at home, the provision unit makes it easier for the user to receive information. When the user is exercising, the provision unit provides information in concise text. By considering the user's current living situation and providing information in concise text during exercise, the provision unit makes it easier for the user to receive information. Thus, the provision unit can provide information in an optimal manner according to the user's current living situation. Specifically, the provision unit collects multidimensional feature vectors (float arrays, 10-50 dimensions) from sensor data of the user terminal (e.g., accelerometer, GPS, Wi-Fi, Bluetooth beacon), in-app behavior logs (e.g., activity detection, screen ON/OFF, app launch history), and external environmental information (e.g., calendar events, time, location information). These feature vectors are input into a living situation estimation AI module. The living situation estimation AI module, for example, uses time-series convolutional neural networks (TCN) or LSTM-type recurrent neural networks to classify the user's current activity state (e.g., commuting, at home, exercising, in a meeting, etc.). Examples of AI input include “Accelerometer: constant speed movement, GPS: near station, time: 8:00”, “Screen ON, Wi-Fi: home SSID, calendar: free time”, etc. The AI output is obtained as living situation labels (e.g., ‘commuting’, ‘at home’, ‘exercising’, etc.) and confidence scores (e.g., float values such as 0.92, 0.85). Examples of output include “Living situation: commuting, confidence 0.93” or “Living situation: at home, confidence 0.88”. Based on the AI output living situation label and confidence, the provision unit dynamically adjusts the parameters of the information provision module (e.g., audio output ON/OFF, visual emphasis, text simplification). For example, during commuting, the audio reading function is enabled and screen display is minimized. At home, visual content such as images and graphs is displayed. During exercise, short text and vibration notifications are used. Examples of information provision generation AI input include “Summary text (300 characters), living situation: commuting” or “Summary text (500 characters), living situation: at home”. Examples of AI output include “Audio reading+concise text” or “Visual emphasis+detailed explanation”. The provision unit automatically optimizes notification methods and expression styles according to the user's living situation. As a subsequent process, user reactions after information provision (e.g., completion rate, re-notification requests, evaluation score) can be fed back to the AI module to continuously improve the accuracy of living situation estimation and information provision optimization through online learning. As a technical effect, the provision unit, unlike conventional uniform notifications or static expression styles, can highly accurately estimate the user's real-time living situation and automatically optimize the information provision flow, thereby greatly improving information receptivity, personalization, and efficiency of understanding. Application fields include personal news readers, information notifications while on the move, health management apps, and learning support in education, among various other use cases. Furthermore, the provision unit is highly extensible, allowing for easy upgrades of living situation estimation AI and information provision generation AI, addition of new living situation labels, and functional expansion through collaboration of multiple AI models (e.g., living situation estimation+information provision+emotion estimation), enabling flexible adaptation to future technological evolution.

The provision unit can estimate the user's emotion and determine the priority of information provision based on the estimated emotion. For example, when the user is excited, the provision unit prioritizes providing entertainment-related information. By estimating the user's emotion and prioritizing entertainment-related information when the user is excited, the provision unit efficiently provides information of interest to the user. When the user is calm, the provision unit prioritizes providing business-related information. By estimating the user's emotion and prioritizing business-related information when the user is calm, the provision unit efficiently provides information of interest to the user. When the user is tired, the provision unit prioritizes providing relaxing content. By estimating the user's emotion and prioritizing relaxing content when the user is tired, the provision unit efficiently provides information of interest to the user. Thus, the provision unit can provide information at an optimal priority according to the user's emotion. Emotion estimation is realized, for example, by using an emotion engine or generative AI with emotion estimation functions. Generative AI may include text generation AI (e.g., LLM) or multimodal generative AI, but is not limited to these examples.

The provision unit can select the method of providing information based on the user's geographic location information at the time of information provision. For example, the provision unit prioritizes providing news related to the region where the user is currently located. By considering the user's geographic location information and prioritizing news related to the current region, the provision unit efficiently provides information of interest to the user. When the user is traveling, the provision unit prioritizes providing news related to the travel destination. By considering the user's geographic location information and prioritizing news related to the travel destination when the user is traveling, the provision unit efficiently provides information of interest to the user. When the user is interested in a specific region, the provision unit prioritizes providing news related to that region. By considering the user's geographic location information and prioritizing news related to the region of interest, the provision unit efficiently provides information of interest to the user. Thus, the provision unit can provide information in an optimal manner based on the user's geographic location information.

The provision unit can analyze the user's social media activity and propose means of provision at the time of information provision. For example, the provision unit provides related information based on news articles shared by the user on social media. By analyzing the user's social media activity and providing related information based on news articles shared by the user, the provision unit efficiently provides information of interest to the user. The provision unit can also provide related information based on the content of posts from accounts followed by the user on social media. By analyzing the user's social media activity and providing related information based on posts from followed accounts, the provision unit efficiently provides information of interest to the user. The provision unit can also provide related information based on news articles liked by the user on social media. By analyzing the user's social media activity and providing related information based on liked news articles, the provision unit efficiently provides information of interest to the user. Thus, the provision unit can provide information in an optimal manner based on the user's social media activity.

The system according to the embodiment is not limited to the examples described above, and various modifications are possible, for example, as follows.

The collection unit can analyze the user's past subscription history and prioritize collecting information from specific news sources. For example, if the user frequently views a particular news site, the collection unit prioritizes collecting news from that site. By analyzing the user's subscription history and prioritizing information from news sources trusted by the user, the collection unit efficiently collects information of interest to the user. The collection unit can also prioritize collecting articles from journalists whose articles the user prefers to read. Thus, the collection unit can collect optimal information based on the user's subscription history.

The extraction unit can analyze the user's past search history and prioritize extracting related unread topics. For example, the extraction unit extracts related news articles based on keywords previously searched by the user. By analyzing the user's search history and prioritizing extraction of topics likely to be of interest to the user, the extraction unit enables the user to efficiently obtain information. The extraction unit can also prioritize extracting unread news articles related to topics in which the user has shown interest. Thus, the extraction unit can extract optimal topics based on the user's search history.

The summarization unit can evaluate the reliability of news articles and prioritize summarizing highly reliable information. For example, the summarization unit prioritizes summarizing information from highly reliable news sources. By evaluating the reliability of news articles and prioritizing highly reliable information, the summarization unit enables users to obtain accurate information. The summarization unit can also evaluate the reliability of sources and authors of news articles and prioritize summarizing highly reliable information. Thus, the summarization unit can provide optimal summaries based on the reliability of news articles.

The provision unit can adjust the method of providing information according to the type of user's device. For example, when using a smartphone, the provision unit provides information mainly in short text and images. By considering the type of user's device and providing information in the optimal format, the provision unit makes it easier for the user to receive information. For example, when using a tablet, the provision unit provides detailed information and interactive content. Thus, the provision unit can provide information in an optimal manner according to the user's device.

The collection unit can adjust the frequency of information collection based on the user's internet connection status. For example, if the user is using a high-speed internet connection, the collection unit collects information frequently. By considering the user's internet connection status and collecting information at the optimal frequency, the collection unit enables the user to efficiently obtain information. For example, if the user is using a low-speed internet connection, the collection unit reduces the frequency of information collection. Thus, the collection unit can collect information at an optimal frequency according to the user's internet connection status.

The extraction unit can estimate the user's emotion and adjust the tone of news to be extracted based on the estimated emotion. For example, if the user is feeling stressed, the extraction unit prioritizes extracting positive news. By estimating the user's emotion and prioritizing positive news when the user is stressed, the extraction unit improves the user's mood. For example, if the user is relaxed, the extraction unit extracts neutral news. Thus, the extraction unit can extract news in an optimal tone according to the user's emotion.

The summarization unit can estimate the user's emotion and adjust the style of the summary based on the estimated emotion. For example, if the user is excited, the summarization unit provides a visually attractive summary. By estimating the user's emotion and providing a visually attractive summary when the user is excited, the summarization unit maintains the user's interest. For example, if the user is calm, the summarization unit provides a detailed summary. Thus, the summarization unit can provide summaries in an optimal style according to the user's emotion.

The provision unit can estimate the user's emotion and adjust the timing of information provision based on the estimated emotion. For example, if the user is busy, the provision unit delays information provision. By estimating the user's emotion and delaying information provision when the user is busy, the provision unit reduces the user's burden. For example, if the user is relaxed, the provision unit provides information immediately. Thus, the provision unit can provide information at an optimal timing according to the user's emotion.

The collection unit can estimate a user's emotion and adjust the type of information to be collected based on the estimated emotion of the user. For example, when the user is sad, the collection unit preferentially collects encouraging messages and positive news. By estimating the user's emotion and preferentially collecting encouraging messages and positive news when the user is sad, the collection unit improves the user's mood. For example, when the user is excited, the collection unit collects entertainment-related information. Thus, the collection unit can collect optimal information according to the user's emotion.

The provision unit can estimate a user's emotion and adjust the format of information provision based on the estimated emotion of the user. For example, when the user is relaxed, the provision unit provides information in a format that includes a large amount of visual content. By estimating the user's emotion and providing information in a format with a large amount of visual content when the user is relaxed, the provision unit makes it easier for the user to receive information. For example, when the user is in a hurry, the provision unit provides information in a concise text format. Thus, the provision unit can provide information in the optimal format according to the user's emotion.

The following is a brief description of the processing flow of Example of the Embodiment.

Step 1: The collection unit collects news information that the user has already read. For example, the collection unit collects information on news links sent from friends via a messenger application and articles already viewed in a news application. The collection unit centrally manages this information and keeps track of which news the user has already read.

Step 2: The extraction unit extracts unread topics based on the read information collected by the collection unit. For example, the extraction unit identifies unread news articles in a news application and unread news links in a messenger application.

Step 3: The summarization unit summarizes the topics extracted by the extraction unit. For example, the summarization unit analyzes the content of unread news articles or news links, extracts important points, and creates a summary. A generative AI is used to condense long news articles into short summaries.

Step 4: The provision unit provides the information summarized by the summarization unit to the user. For example, the provision unit utilizes the notification function of a news application or a messenger application to provide the summarized information to the user. In this way, the provision unit quickly provides summarized information so that the user can efficiently obtain information.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL:https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the above-described collection unit, extraction unit, summarization unit, and provision unit is implemented by at least one of, for example, a smart device 14 and a data processing apparatus 12. For example, the collection unit is implemented by a control unit 46A of the smart device 14 and collects read information from a messenger application or a news application. The extraction unit is implemented, for example, by a specific processing unit 290 of the data processing apparatus 12 and extracts unread topics based on the collected read information. The summarization unit is implemented, for example, by the specific processing unit 290 of the data processing apparatus 12 and summarizes the extracted topics. The provision unit is implemented, for example, by the control unit 46A of the smart device 14 and provides the summarized information to the user. The correspondence between each unit and the apparatus or control unit is not limited to the above examples and various modifications are possible.

### Second Embodiment

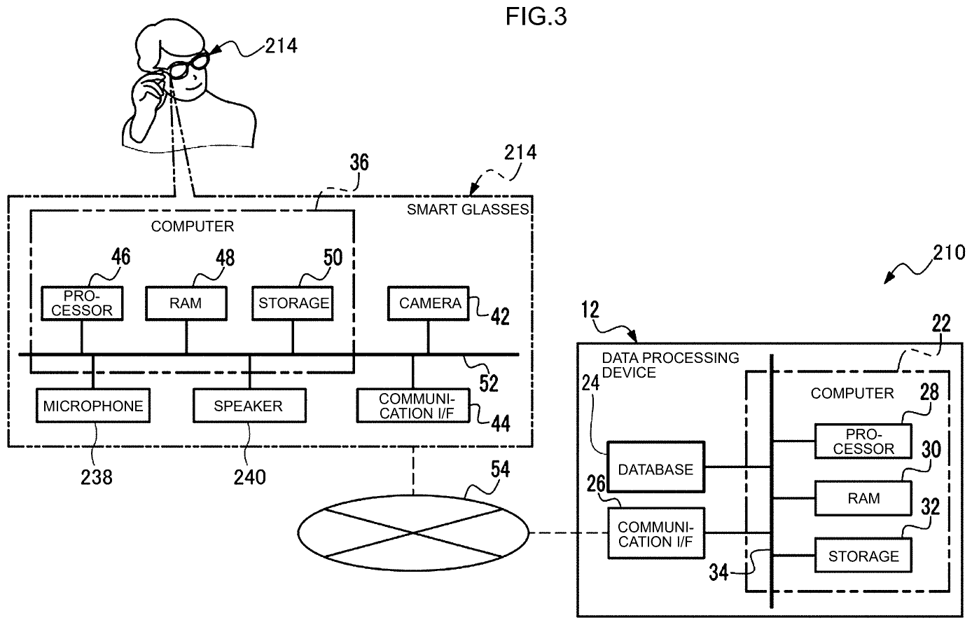

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

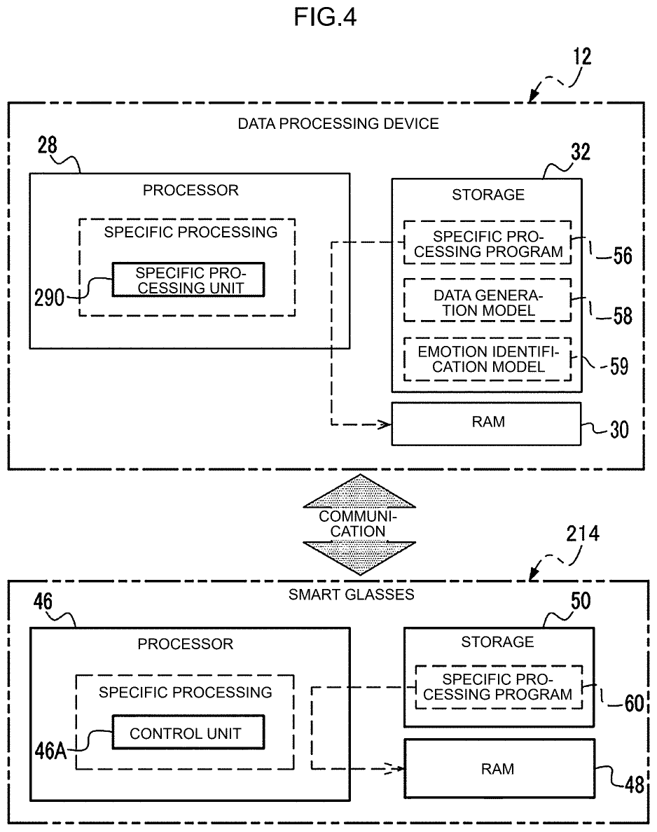

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the above-described collection unit, extraction unit, summarization unit, and provision unit is implemented by at least one of, for example, smart glasses 214 and a data processing apparatus 12. For example, the collection unit is implemented by a control unit 46A of the smart glasses 214 and collects read information from a messenger application or a news application. The extraction unit is implemented, for example, by a specific processing unit 290 of the data processing apparatus 12 and extracts unread topics based on the collected read information. The summarization unit is implemented, for example, by the specific processing unit 290 of the data processing apparatus 12 and summarizes the extracted topics. The provision unit is implemented, for example, by the control unit 46A of the smart glasses 214 and provides the summarized information to the user. The correspondence between each unit and the apparatus or control unit is not limited to the above examples and various modifications are possible.

### Third Embodiment

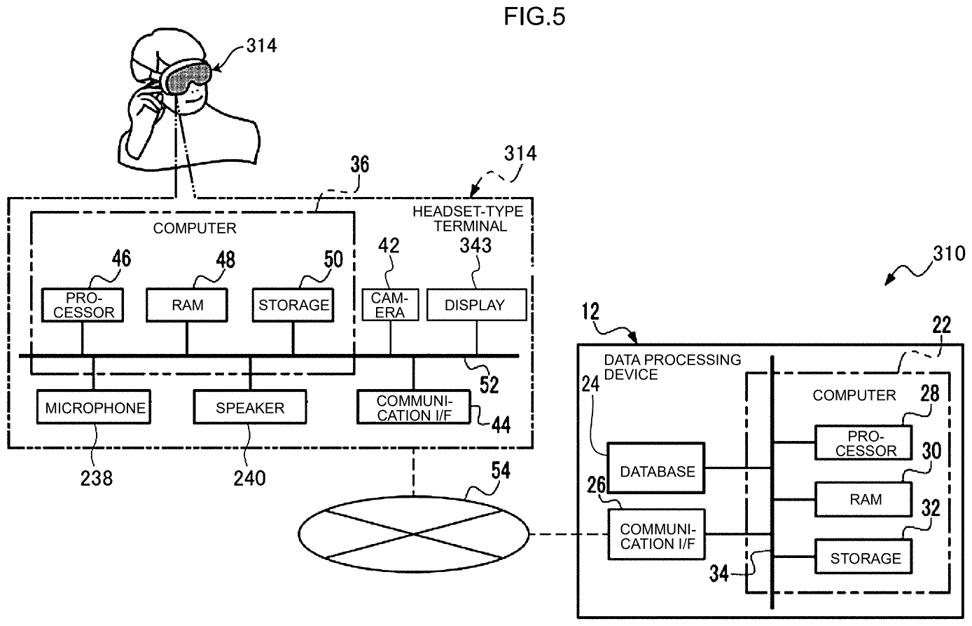

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

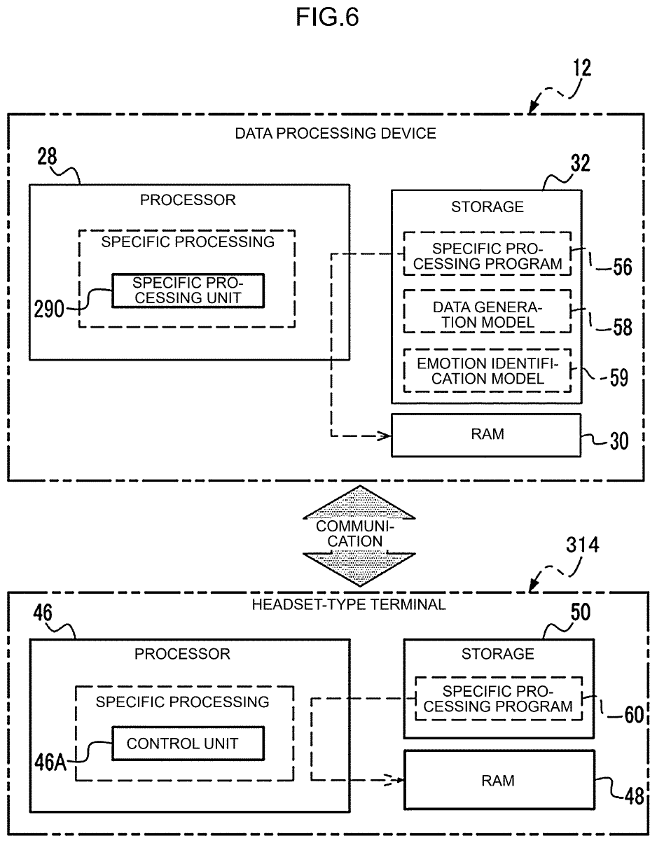

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the above-described collection unit, extraction unit, summarization unit, and provision unit is implemented by at least one of, for example, a headset-type terminal 314 and a data processing apparatus 12. For example, the collection unit is implemented by a control unit 46A of the headset-type terminal 314 and collects read information from a messenger application or a news application. The extraction unit is implemented, for example, by a specific processing unit 290 of the data processing apparatus 12 and extracts unread topics based on the collected read information. The summarization unit is implemented, for example, by the specific processing unit 290 of the data processing apparatus 12 and summarizes the extracted topics. The provision unit is implemented, for example, by the control unit 46A of the headset-type terminal 314 and provides the summarized information to the user. The correspondence between each unit and the apparatus or control unit is not limited to the above examples and various modifications are possible.

### Fourth Embodiment

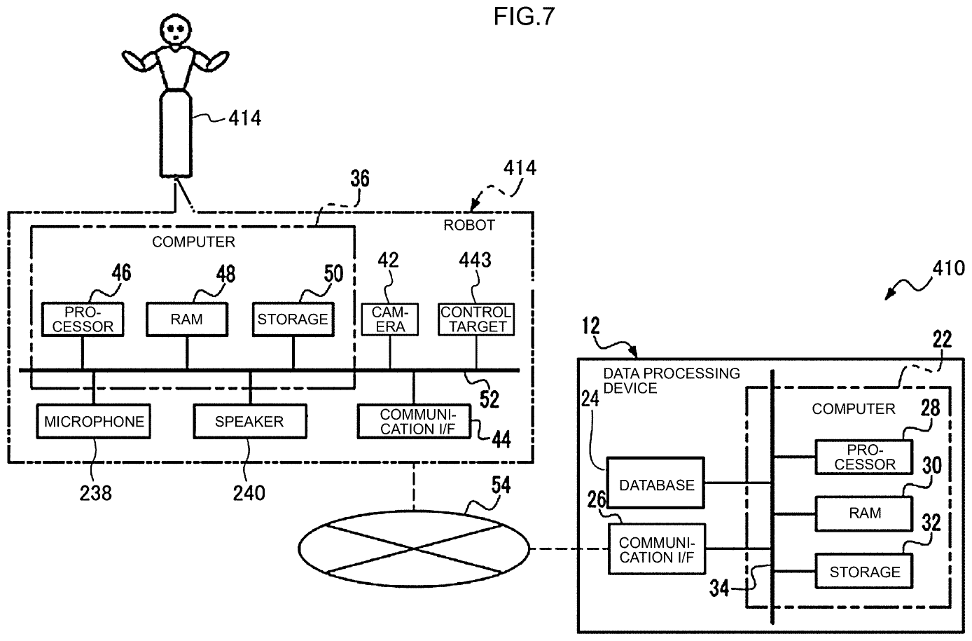

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

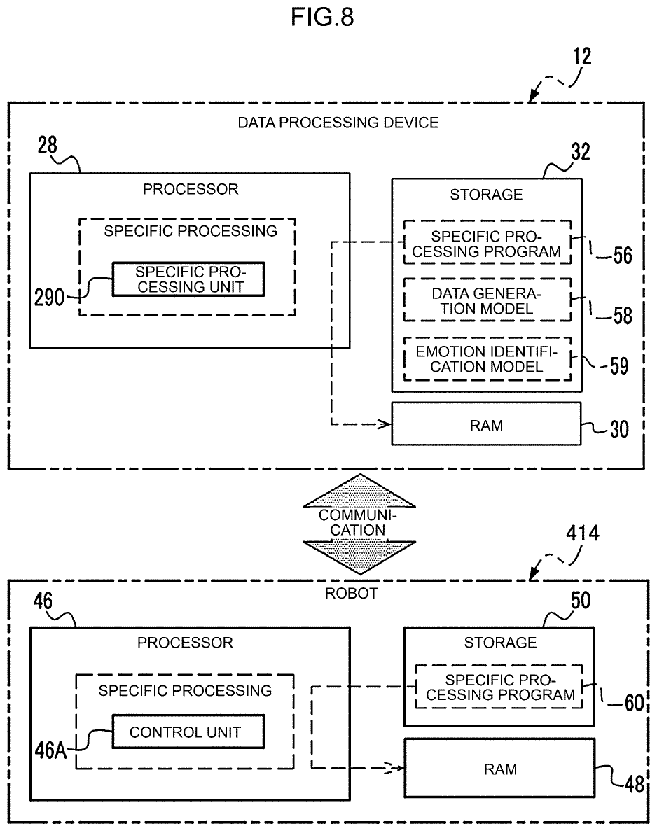

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the above-described collection unit, extraction unit, summarization unit, and provision unit is implemented by at least one of, for example, a robot 414 and a data processing apparatus 12. For example, the collection unit is implemented by a control unit 46A of the robot 414 and collects read information from a messenger application or a news application. The extraction unit is implemented, for example, by a specific processing unit 290 of the data processing apparatus 12 and extracts unread topics based on the collected read information. The summarization unit is implemented, for example, by the specific processing unit 290 of the data processing apparatus 12 and summarizes the extracted topics. The provision unit is implemented, for example, by the control unit 46A of the robot 414 and provides the summarized information to the user. The correspondence between each unit and the apparatus or control unit is not limited to the above examples and various modifications are possible.

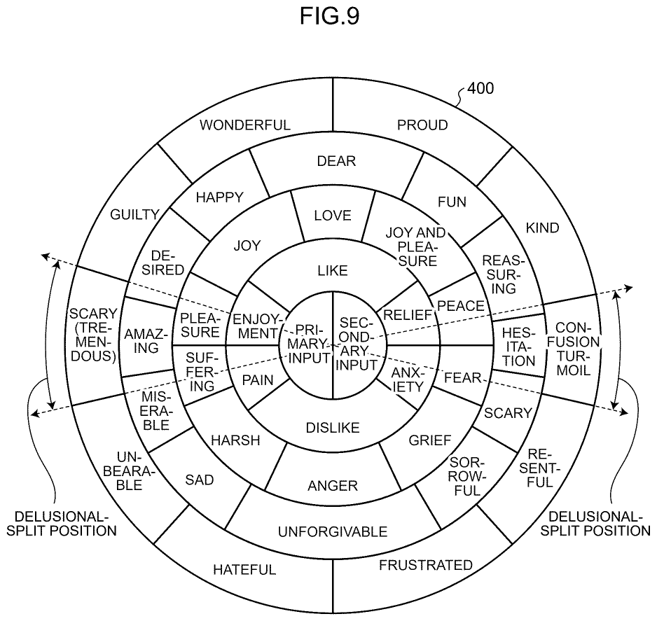

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

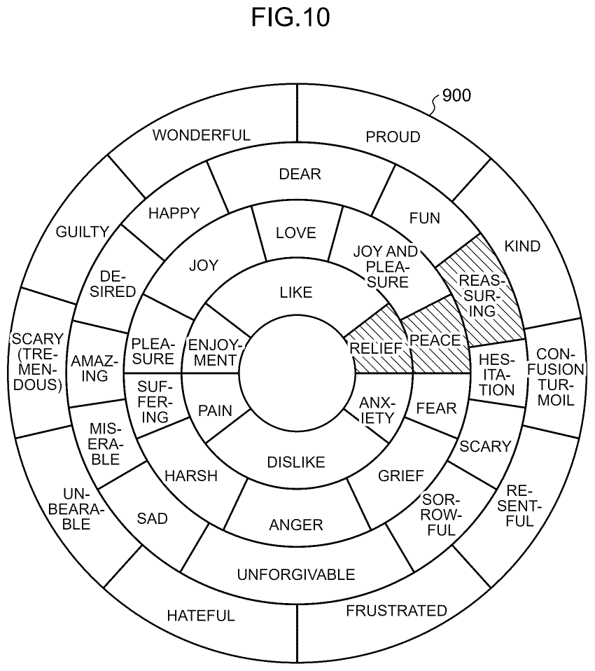

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

(Supplementary Note 1) A system comprising: a collection unit configured to collect read information; an extraction unit configured to extract unread topics based on the read information collected by the collection unit; a summarization unit configured to summarize the topics extracted by the extraction unit; and a provision unit configured to provide the information summarized by the summarization unit.

(Supplementary Note 2) The system according to Supplementary Note 1, wherein the summarization unit analyzes the content of unread news articles or news links and creates a summary by extracting important points.

(Supplementary Note 3) The system according to Supplementary Note 1, wherein the provision unit provides the summarized information to a user by utilizing a notification function of a news application or a messenger application.

(Supplementary Note 4) The system according to Supplementary Note 1, wherein the collection unit collects information on news links sent from friends via a messenger application or articles already viewed in a news application.

(Supplementary Note 5) The system according to Supplementary Note 1, wherein the extraction unit identifies unread news articles in a news application or unread news links in a messenger application.

(Supplementary Note 6) The system according to Supplementary Note 1, wherein the collection unit estimates a user's emotion and adjusts the timing of collecting read information based on the estimated emotion of the user.

(Supplementary Note 7) The system according to Supplementary Note 1, wherein the collection unit analyzes a user's past browsing history and selects a collection method.

(Supplementary Note 8) The system according to Supplementary Note 1, wherein the collection unit performs filtering based on the user's current field of interest when collecting read information.

(Supplementary Note 9) The system according to Supplementary Note 1, wherein the collection unit estimates a user's emotion and determines the priority of read information to be collected based on the estimated emotion of the user.

(Supplementary Note 10) The system according to Supplementary Note 1, wherein the collection unit preferentially collects highly relevant information based on the user's geographic location information when collecting read information.

(Supplementary Note 11) The system according to Supplementary Note 1, wherein the collection unit analyzes the user's social media activity and collects related information when collecting read information.

(Supplementary Note 12) The system according to Supplementary Note 1, wherein the extraction unit estimates a user's emotion and adjusts the criteria for extracting unread topics based on the estimated emotion of the user.

(Supplementary Note 13) The system according to Supplementary Note 1, wherein the extraction unit improves extraction accuracy based on interrelationships among news articles during extraction.

(Supplementary Note 14) The system according to Supplementary Note 1, wherein the extraction unit applies different extraction algorithms for each category of news articles during extraction.

(Supplementary Note 15) The system according to Supplementary Note 1, wherein the extraction unit estimates a user's emotion and determines the priority of topics to be extracted based on the estimated emotion of the user.

(Supplementary Note 16) The system according to Supplementary Note 1, wherein the extraction unit performs extraction based on the geographic distribution of news articles during extraction.

(Supplementary Note 17) The system according to Supplementary Note 1, wherein the extraction unit improves extraction accuracy based on related literature of news articles during extraction.

(Supplementary Note 18) The system according to Supplementary Note 1, wherein the summarization unit estimates a user's emotion and adjusts the expression method of the summary based on the estimated emotion of the user.

(Supplementary Note 19) The system according to Supplementary Note 1, wherein the summarization unit adjusts the level of detail of the summary based on the importance of news articles when generating the summary.

(Supplementary Note 20) The system according to Supplementary Note 1, wherein the summarization unit applies different summarization algorithms according to the category of news articles when generating the summary.

(Supplementary Note 21) The system according to Supplementary Note 1, wherein the summarization unit estimates a user's emotion and adjusts the length of the summary based on the estimated emotion of the user.

(Supplementary Note 22) The system according to Supplementary Note 1, wherein the summarization unit determines the priority of the summary based on the submission timing of news articles when generating the summary.

(Supplementary Note 23) The system according to Supplementary Note 1, wherein the summarization unit adjusts the order of the summary based on the relevance of news articles when generating the summary.

(Supplementary Note 24) The system according to Supplementary Note 1, wherein the provision unit estimates a user's emotion and adjusts the method of providing information based on the estimated emotion of the user.

(Supplementary Note 25) The system according to Supplementary Note 1, wherein the provision unit selects a provision method based on the user's past browsing history when providing information.

(Supplementary Note 26) The system according to Supplementary Note 1, wherein the provision unit customizes the means of provision based on the user's current living situation when providing information.

(Supplementary Note 27) The system according to Supplementary Note 1, wherein the provision unit estimates a user's emotion and determines the priority of information provision based on the estimated emotion of the user.

(Supplementary Note 28) The system according to Supplementary Note 1, wherein the provision unit selects a provision method based on the user's geographic location information when providing information.

(Supplementary Note 29) The system according to Supplementary Note 1, wherein the provision unit analyzes the user's social media activity and proposes means of provision when providing information.

What is claimed is:

1. A system comprising:
a communication interface configured to communicate with a client terminal via a packet-switched network;
a processor;
a random-access memory;
a memory storing a data generation model comprising an encoder-decoder Transformer architecture obtained by deep learning on a neural network, and an emotion identification model;
a database; and
circuitry configured to:
receive, from the client terminal via the communication interface, text data and sensor data;
store the text data in the database;
estimate an emotion of the user by applying the emotion identification model to the sensor data;
tokenize the text data using subword segmentation to generate a token sequence of up to 4,096 tokens, input the token sequence into the data generation model, and generate summary data from an output of the encoder-decoder Transformer architecture, the summary data comprising a condensed natural-language representation of the text data;
adjust at least one of a length or a level of detail of the summary data based on the estimated emotion; and
transmit the summary data to the client terminal via the communication interface and the packet-switched network, the summary data causing the client terminal to output the summary data to the user.

2. The system according to claim 1, wherein the circuitry is further configured to receive, from the client terminal via the communication interface, read status data comprising content identifiers and read flags indicating content items that the user has accessed, store the read status data in the database, and identify unread content items by comparing the read status data with metadata of a plurality of content items stored in the database, and wherein the text data comprises body text of the identified unread content items.

3. The system according to claim 2, wherein the circuitry is further configured to identify the unread content items using at least one of a hash table or a bitmap index.

4. The system according to claim 1, wherein the circuitry is further configured to perform post-processing on the summary data comprising at least one of personalized filtering based on a browsing tendency of the user stored in the database, or quality evaluation of the summary data using at least one of a ROUGE score or a BLEU score.

5. The system according to claim 1, wherein the emotion identification model comprises a multimodal Transformer architecture, and wherein the circuitry is configured to estimate the emotion by inputting at least one of voice data, a face image, text input, or biometric sensor data received from the client terminal into the emotion identification model to generate an emotion label and a confidence score.

6. The system according to claim 1, wherein the circuitry is further configured to adjust a timing of receiving the text data from the client terminal based on the estimated emotion, such that when the estimated emotion indicates stress, the circuitry delays the receiving, and when the estimated emotion indicates relaxation, the circuitry receives the text data immediately.

7. The system according to claim 1, wherein the circuitry is further configured to analyze a browsing history of the user stored in the database to generate a browsing tendency comprising at least one of a category-based browsing frequency vector or a time-of-day access histogram, and to select a category of the text data to receive from the client terminal based on the browsing tendency.

8. The system according to claim 1, wherein the circuitry is further configured to determine a priority of the text data to receive based on the estimated emotion, such that when the estimated emotion indicates excitement, the circuitry prioritizes text data having an entertainment attribute, and when the estimated emotion indicates calmness, the circuitry prioritizes text data having a business attribute.

9. The system according to claim 1, wherein the circuitry is further configured to receive geographic location information from the client terminal via the communication interface, and to prioritize receiving text data associated with a geographic region corresponding to the geographic location information.

10. The system according to claim 1, wherein the circuitry is further configured to receive social media activity data of the user from the client terminal via the communication interface, and to select the text data to receive based on the social media activity data.

11. The system according to claim 1, wherein the circuitry is further configured to store metadata of the text data in a graph-structured database, quantify interrelationships among the text data using at least one of community detection or PageRank, and group the text data based on the quantified interrelationships.

12. The system according to claim 1, wherein the circuitry is further configured to apply different analysis algorithms according to a category of the text data, such that for text data in an entertainment category, the circuitry applies an emotion analysis algorithm, and for text data in a business category, the circuitry applies an economic indicator extraction algorithm.

13. The system according to claim 1, wherein the circuitry is further configured to adjust an expression style of the summary data based on the estimated emotion, such that when the estimated emotion indicates relaxation, the summary data is generated in a detailed expression style, and when the estimated emotion indicates urgency, the summary data is generated in a concise expression style.

14. The system according to claim 1, wherein the circuitry is further configured to calculate an importance score for each item of the text data, and to adjust the level of detail of the summary data based on the importance score, such that text data having a high importance score is summarized in detail and text data having a low importance score is summarized concisely.

15. The system according to claim 1, wherein the circuitry is further configured to apply different summarization algorithms according to a category of the text data.

16. The system according to claim 1, wherein the circuitry is further configured to determine a priority of generating the summary data based on a timestamp associated with the text data, such that text data having a more recent timestamp is summarized with a higher priority.

17. The system according to claim 1, wherein the circuitry is further configured to select a method of transmitting the summary data to the client terminal based on at least one of the estimated emotion or a browsing history of the user stored in the database, the method comprising at least one of a push notification, a banner display, or a widget display.

18. A system comprising:
a communication interface configured to communicate, via a packet-switched network conforming to at least one of a 5G, Wi-Fi, or Bluetooth communication standard, with a client terminal comprising a touch panel, a microphone, a speaker, a camera having a CMOS image sensor, and a display;
a processor;
a random-access memory;
a memory storing a data generation model comprising an encoder-decoder Transformer architecture obtained by deep learning on a neural network, and an emotion identification model;
a database; and
circuitry configured to:
receive, from the client terminal via the communication interface, text data and sensor data comprising at least one of voice data captured by the microphone or image data captured by the camera;
store the text data in the database;
estimate an emotion of the user by applying the emotion identification model to the sensor data;
tokenize the text data using subword segmentation to generate a token sequence, input the token sequence into the data generation model, and generate summary data from an output of the encoder-decoder Transformer architecture;
adjust at least one of a length, a level of detail, or an expression style of the summary data based on the estimated emotion; and
transmit the summary data to the client terminal via the communication interface and the packet-switched network, the summary data causing the client terminal to output the summary data to the user via at least one of the display or the speaker.

19. The system according to claim 18, wherein the data generation model comprises at least one of a text generation AI, an image generation AI, or a multimodal generation AI, and wherein the data generation model is a fine-tuned model configured to output inference results from prompts without instructions.

20. A method performed by circuitry of a data processing system comprising a processor, a random-access memory, a memory storing a data generation model comprising an encoder-decoder Transformer architecture obtained by deep learning on a neural network and an emotion identification model, a database, and a communication interface, the method comprising:
receiving, from a client terminal via the communication interface and a packet-switched network, text data and sensor data;
storing the text data in the database;
estimating an emotion of a user by applying the emotion identification model to the sensor data;
tokenizing the text data using subword segmentation to generate a token sequence of up to 4,096 tokens, inputting the token sequence into the data generation model, and generating summary data from an output of the encoder-decoder Transformer architecture, the summary data comprising a condensed natural-language representation of the text data;
adjusting at least one of a length or a level of detail of the summary data based on the estimated emotion; and
transmitting the summary data to the client terminal via the communication interface and the packet-switched network, the summary data causing the client terminal to output the summary data to the user.
